(19) United States
(12) Patent Application Publication
(10) Pub. No.: US 2024/0053648 A1
(43) Pub. Date: Feb. 15, 2024

(54) Reversible Electrochemical Mirror (REM)

(71) Applicant: Nanyang Technological University, Singapore (SG)

(72) Inventors: Pooi See LEE, Singapore (SG); Alice Lee Sie EH, Singapore (SG)

(21) Appl. No.: 18/266,889

(22) PCT Filed: Dec. 17, 2021
(86) PCT No.: PCT/SG2021/050795

§ 371 Date: Jun. 13, 2023

(30) Foreign Application Priority Data
Dec. 17, 2020 (SG) 10202012699T

(51) Int. Cl. G02F 1/1523

(52) U.S. Cl. CPC G02F 1/1525

(57) ABSTRACT

The present disclosure refers to a reversible electrochemical device, wherein the electrolytic solution comprises a deep eutectic solvent, at least about 20 wt % aqueous solvent based on the total weight of deep eutectic solvent and aqueous solvent, and a metal salt. The present disclosure also refers to a use of an electrolytic solution in a reversible electrochemical mirror, wherein the electrolytic solution comprises a deep eutectic solvent; at least about 20 wt % 0 aqueous solvent based on the total weight of deep eutectic solvent and aqueous solvent; and metal salt.

### TECHNICAL FIELD

The present disclosure relates to reversible electrochemical minors. The present disclosure further relates to uses of electrolytic solutions in reversible electrochemical minors.

### BACKGROUND ART

Non-aqueous electrolytes are highly desirable for their excellent electrochemical performance, high electrochemical stability, and wide electrochemical potential window in electrolytic devices. However, the main concerns with non-aqueous electrolytes include inherent safety problems associated with high sensitivity to the ambient atmosphere, toxicity, volatility, and flammability. For example, in the event of accidental thermal runaway, non-aqueous electrolytes act as fuel during the chemical combustion. Hence, the push for new electrolyte chemistries with enhanced safety has become intense, especially in light of several high-profile explosion incidents and subsequent recalls involving lithium batteries. The development of the next generation electrolyte has marked safety as one of the top priorities in addition to delivering high performance and reliability.

In recent years, aqueous electrolytes have drawn immense attention owing to their non-flammability, non-toxicity, high tolerance against abuse and environmental moisture, and low capital investment, making them desirable for energy storage applications. It is noteworthy however that an aqueous-based reversible electrochemical minor (REM) electrolyte has yet to be realized. The relatively narrow voltage window of water prohibits the electrodeposition of metals such as palladium, zinc, titanium, and chromium as a result of hydrogen evolution and poor current efficiencies. Furthermore, their practical applications have been hindered by poor electrochemical stability, which severely restricts their widespread adoption. The electrochemical instability of water is characterized by its limited potential window (1.23 V), excluding them from high-energy rechargeable batteries and realization of REM electrochromic devices.

Hence, there is a need to provide new electrolytes for REMs that overcome, or at least ameliorate, one or more of the disadvantages described above.

### SUMMARY

In an aspect of the present disclosure, there is provided a reversible electrochemical minor (REM) comprising an electrolytic solution, wherein the electrolytic solution comprises:
deep eutectic solvent;
at least about 20 wt % aqueous solvent based on the total weight of deep eutectic solvent and aqueous solvent; and
metal salt.

Advantageously, the REM, possessing both deep eutectic solvent and aqueous solvent in its electrolytic solution, offers a wider electrochemical voltage window than a REM comprising fully aqueous electrolyte to allow complete reduction and oxidation of metal ions. The REM of the present disclosure also possesses a higher current efficiency as compared to REMs comprising fully non-aqueous electrolytes.

The REM of the present disclosure also advantageously possesses the ability to tailor redox peak position, promoting the electrochemical activity of the metal salt.

In another aspect of the present disclosure, there is provided a reversible electrochemical minor (REM), comprising:
a first electrode;
a second electrode deposited with metal atoms; and
an electrolytic solution defined in any one of claims 1 to 18, wherein the electrolytic solution is disposed between the first electrode and second electrode,
wherein the application of negative potential on the first electrode relative to the second electrode causes the deposited metal atoms to be dissolved from the second electrode into the electrolytic solution and to be electrodeposited from the electrolytic solution onto the first electrode; and
wherein the application of positive potential on the first electrode relative to the second electrode causes the deposited metal atoms to be dissolved from the first electrode into the electrolytic solution and to be electrodeposited from the electrolytic solution onto the second electrode.

The REM may advantageously offer up to three modulation states, a transparent state, a semi-transparent state, and a complete mirror state. The reversible electrochemical minor in the present disclosure has also been shown to possess high cycling stability with minimal degradation in transmittance modulation. The REM of the present disclosure also possesses an unexpected memory effect not shown by any conventional REM.

In a further aspect of the present disclosure, there is provided a use of an electrolytic solution in a reversible electrochemical mirror, wherein the electrolytic solution comprises:
deep eutectic solvent;
at least about 20 wt % aqueous solvent based on the total weight of deep eutectic solvent and aqueous solvent; and
metal salt.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, the term “reversible electrochemical mirror” (REM) refers to a device that is able to modulate its reflectance from a highly reflective state to a highly transparent state and vice versa in response to an applied current.

As used herein, the term “deep eutectic solvent” (DES) refers to solution of Lewis or Brønsted acids and bases which forms a eutectic mixture.

As used herein, the term “aqueous solvent” refers to solvent that is miscible with water, or consists of water.

As used herein, the term “electrochemical mediator” refers to a chemical that has a suitable redox potential to facilitate the electrochemical reaction.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

### Key

| | |
|---|---|
| Water electrolyte | Water and 80 mM copper chloride (CuCl₂) |
| DES electrolyte | Choline chloride (ChCl):glycerol at 1:3, |
| | and 80 mM CuCl₂ |
| Hybrid electrolyte (also | Composition of Example 1a: |
| referred to as electrolytic | DES (ChCl:glycerol, 1:3) |
| solution) | water (DES:water, 7:3) |
| | CuCl₂ (80 mM) |
| Quasi-solid-state solution | Composition of Example 1b: |
| | DES (ChCl:glycerol, 1:3) |
| | water (DES:water, 7:3) |
| | CuCl₂ (80 mM) |
| | KI (6 mM) |
| | gelatin (1 wt %) |
| DMSO-based electrolyte | CuCl₂ (80 mM) |
| | LiClO₄ (250 mM) |
| | KI (0.6 mM) |
| | PVA (10 wt %) |
| | DMSO |

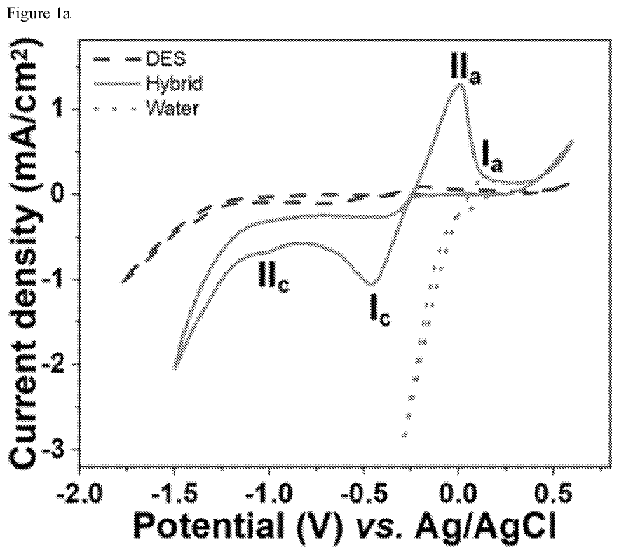

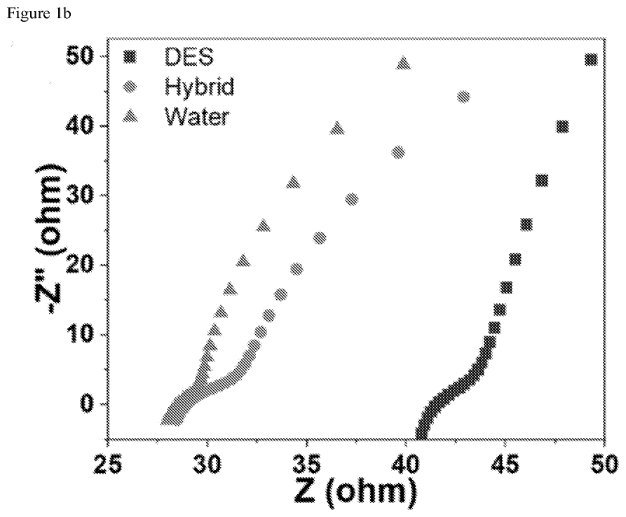

FIG. 1a is a cyclic voltammogram graph of copper (Cu) film electrodeposition/dissolution on fluorine doped tin oxide (FTO) electrode (vs. Ag/AgCl) in water electrolyte, DES electrolyte and hybrid electrolyte. Three-electrode electrochemical testing was done according to Example 1e.

FIG. 1b is a graph showing the enlarged area of the high frequency region of a Nyquist plot from the Electrochemical Impedance Spectroscopy (EIS) spectra a REM of Example 2a using water electrolyte, DES electrolyte and hybrid electrolyte.

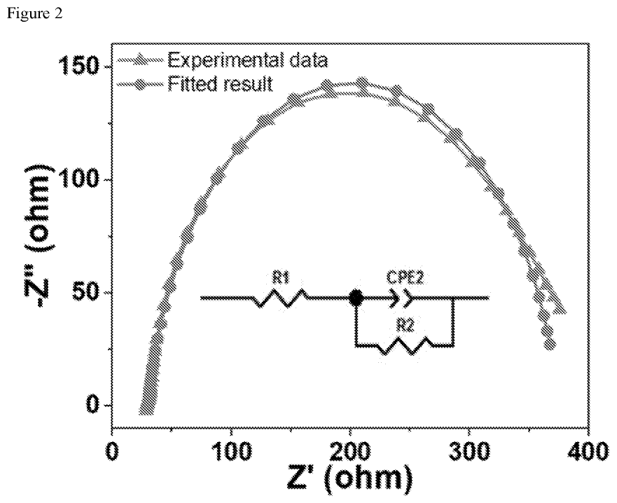

FIG. 2 is a graph showing the fitted Electrochemical Impedance Spectroscopy (EIS) spectra obtained by ZView software using experimental data of a REM of Example 2a using hybrid electrolyte. Inset is the equivalent circuit used to model the EIS data of hybrid electrolyte determined by the ZView software.

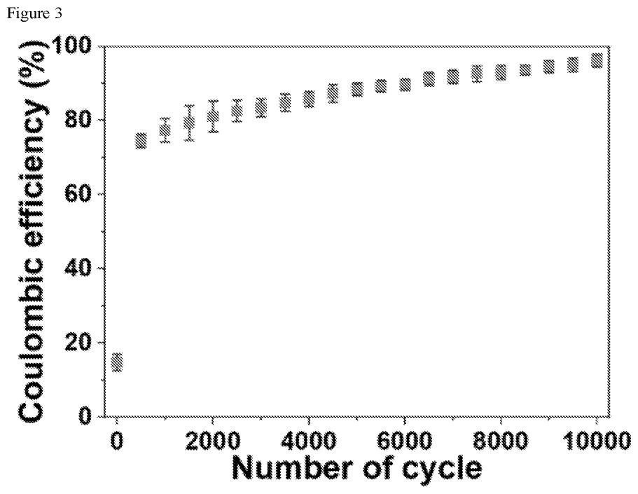

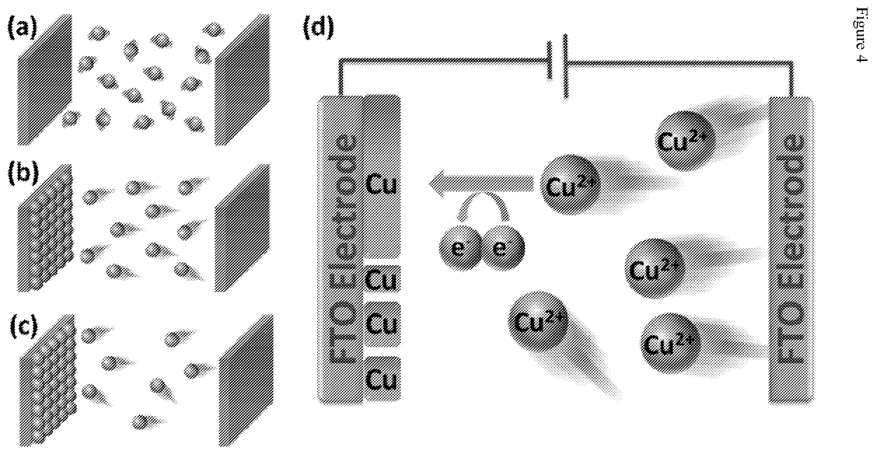

FIG. 3 is a graph showing the coulombic efficiency of Cu film electrodeposition/dissolution on FTO electrode in the hybrid electrolyte. Three-electrode electrochemical testing was done according to Example 1e.

FIG. 4 is a schematic showing the random distribution of the Cu²⁺ ions in a REM of Example 2b using hybrid electrolyte, (a) when no voltage is applied; (b) forming a red colored film at −0.5 V vs. Ag/AgCl; and (c) forming a Cu mirror film at −1.0 V vs. Ag/AgCl. (d) is an illustration showing the electrodeposition process of Cu²⁺ ions to form a Cu mirror film at −1.0 V vs. Ag/AgCl.

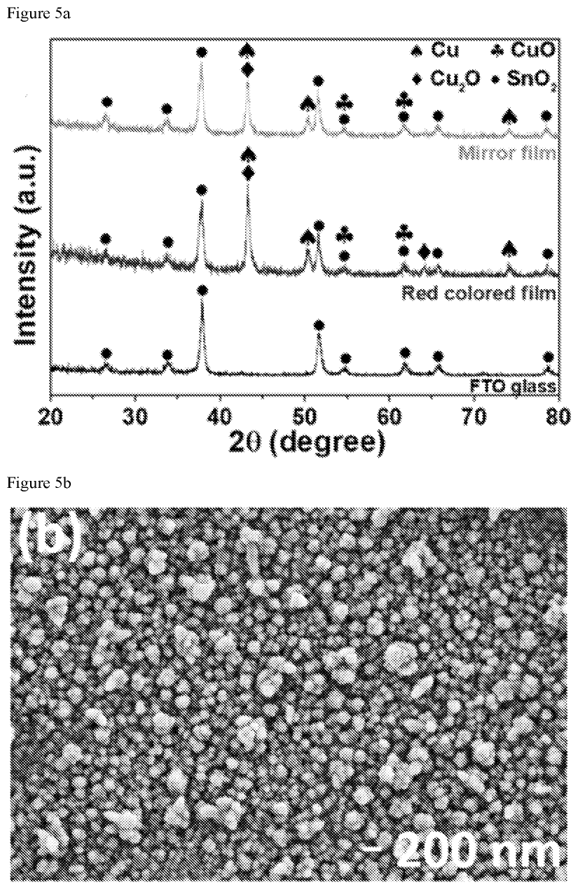

FIG. 5a is a graph showing the X-Ray Diffraction (XRD) diffraction patterns of FTO electrode, red colored film/FTO electrode (at −0.5 V applied voltage), and mirror film/FTO electrode (at −1.2 V applied voltage) from hybrid electrolyte.

FIG. 5b is a Scanning Electron Microscopy (SEM) image of Cu mirror film electrochemically deposited at −1.2 V for 120 seconds onto FTO electrode from hybrid electrolyte.

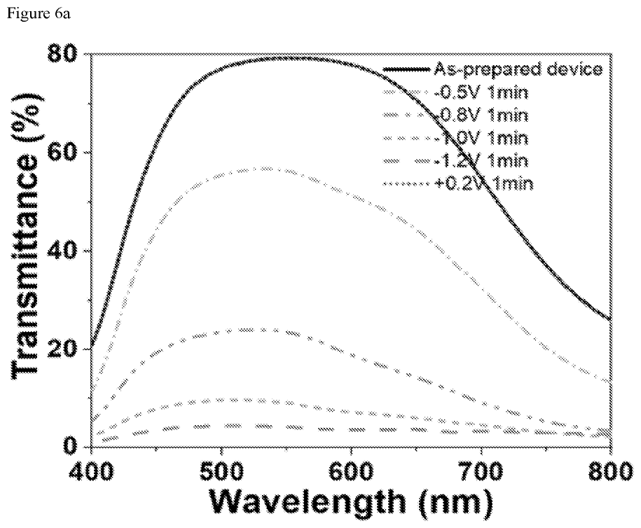

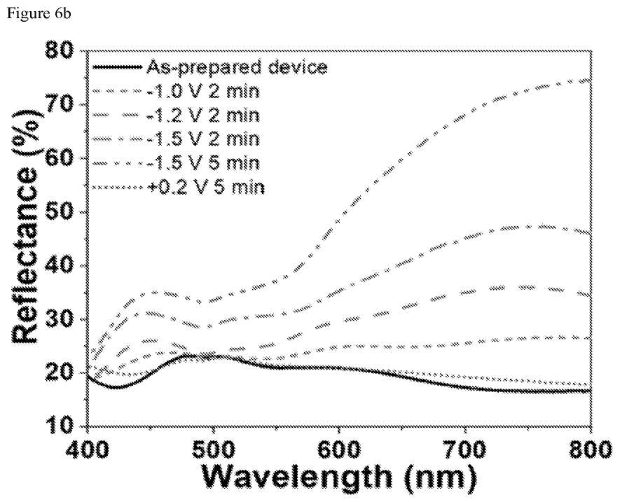

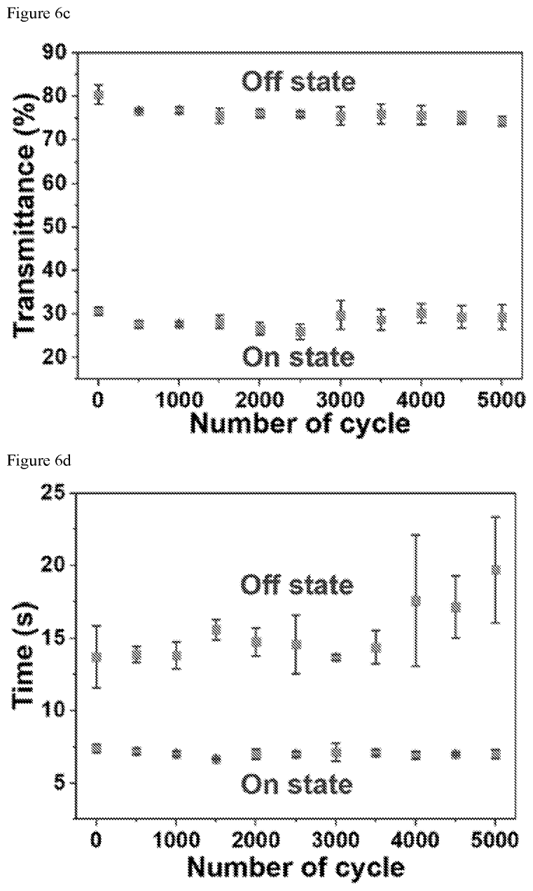

FIG. 6a is a spectrum showing in situ transmittance of Cu film electrodeposition/dissolution from hybrid electrolyte in a REM of Example 2b at various voltages.

FIG. 6b is a spectra showing the in situ reflectance of the Cu film electrodeposition/dissolution from hybrid electrolyte in a REM of Example 2b at various voltages.

FIG. 6c is a graph showing the cycling performance of hybrid electrolyte (in terms of reversible electrodeposition and dissolution vs. Ag/AgCl) using voltage algorithms (VA1: −1.0 V (10 seconds), 0 V (30 seconds), +0.5 V (20 seconds), and 0 V (10 seconds)) at 550 nm in the transmittance mode. Three-electrode electrochemical cuvette testing was done according to Example 1f.

FIG. 6d is a graph showing the corresponding cycle kinetics of hybrid electrolyte at different switching cycles. Three-electrode electrochemical cuvette testing was done according to Example 1f.

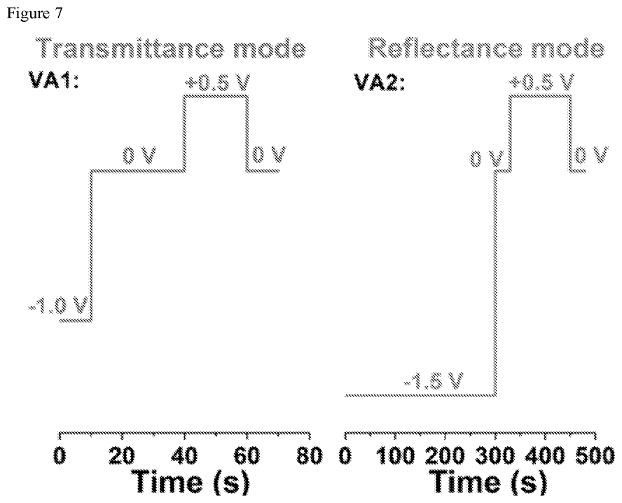

FIG. 7 is a graph showing voltage algorithms (VA1 and VA2) in waveforms applied for the cycling performance of hybrid electrolyte in transmittance mode and reflectance mode. Three-electrode electrochemical cuvette testing was done according to Example 1f.

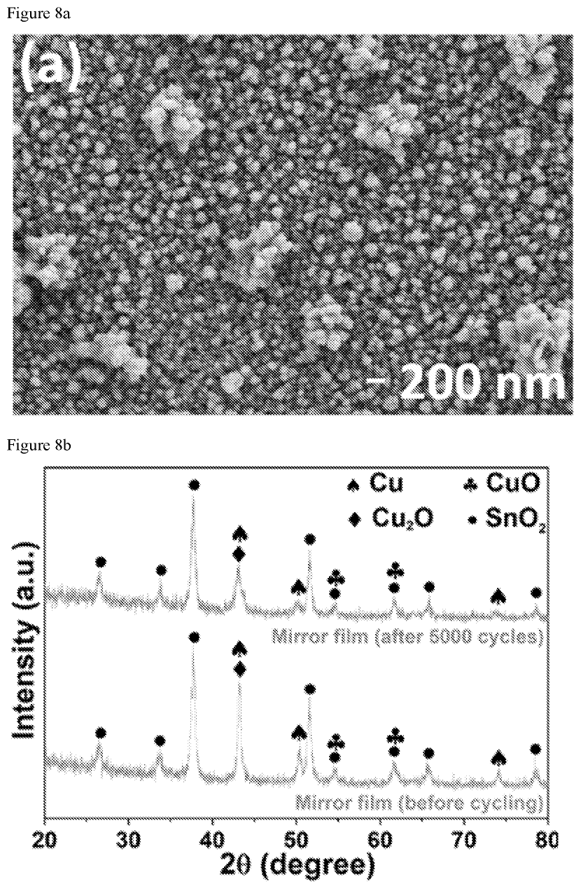

FIG. 8a is a Scanning Electron Microscopy (SEM) image of Cu film/FTO electrode at −1.2 V for 120 seconds after cycling (5,000 cycles). Three-electrode electrochemical cuvette testing was done according to Example 1f.

FIG. 8b is a graph showing the X-Ray Diffraction (XRD) patterns of Cu mirror film/FTO electrode before and after cycling (5,000 cycles). Three-electrode electrochemical cuvette testing was done according to Example 1f.

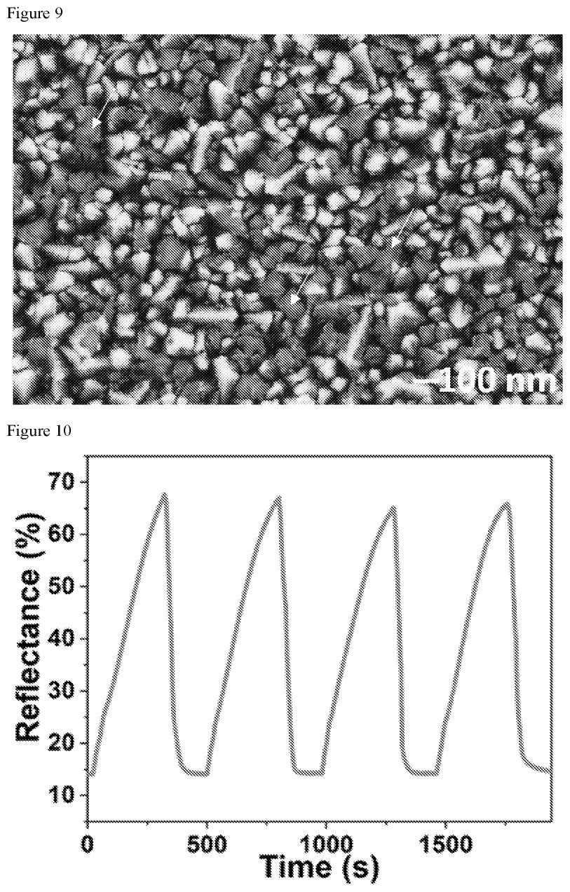

FIG. 9 is an image showing non-dissolved Cu nanoparticles in grey color on FTO electrode after dissolution at +0.50 V (after 30 cycles of VA1). The particles have been additionally indicated by white arrows. Three-electrode electrochemical cuvette testing was done according to Example 1f.

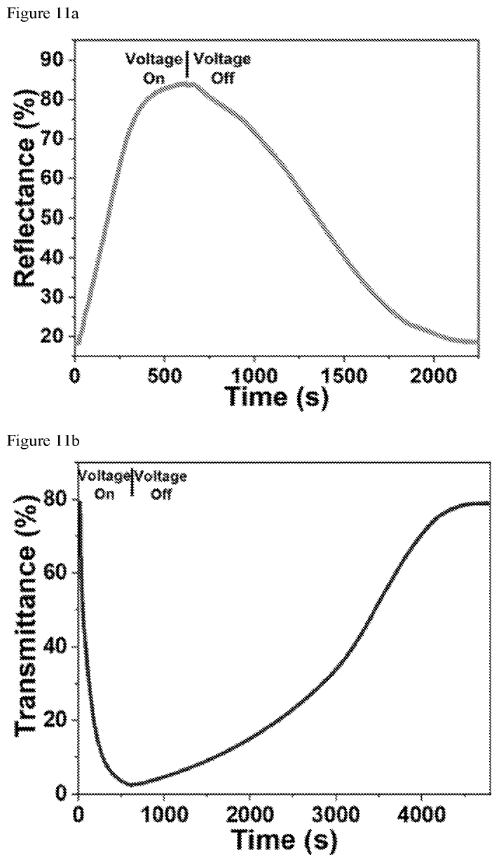

FIG. 10 is a graph showing the in-situ reflectance response of the electrodeposition/dissolution of Cu film on FTO electrode from hybrid electrolyte vs. Ag/AgCl. Three-electrode electrochemical cuvette testing was done according to Example 1f.

FIG. 11a is a graph showing the memory effect retention of the mirror state of a REM of Example 2b using hybrid electrolyte in reflectance mode (at 780 nm) during the voltage-off state after applying a voltage of −1.5 V for 10 minutes.

FIG. 11b is a graph showing the memory effect retention of the colored state of a REM of Example 2b using hybrid electrolyte in transmittance mode (at 550 nm) during the voltage-off state after applying a voltage of −0.8 V for 10 min.

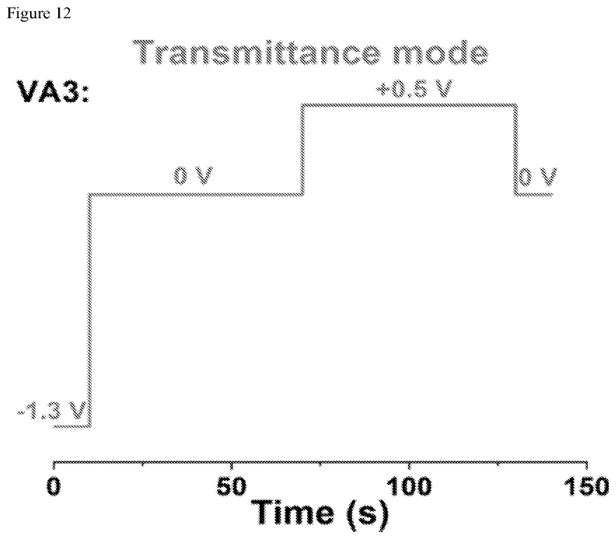

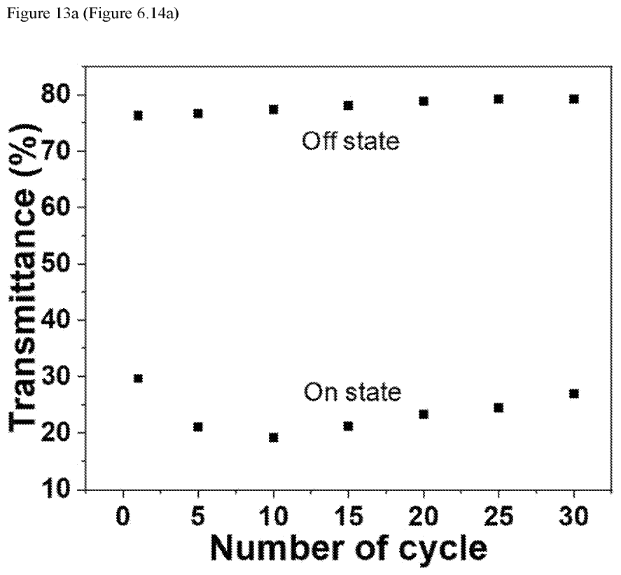

FIG. 12 is a graph showing voltage algorithm (VA3) in waveform applied for the cycling test of a REM of Example 2b using quasi-solid-state solution in transmittance mode.

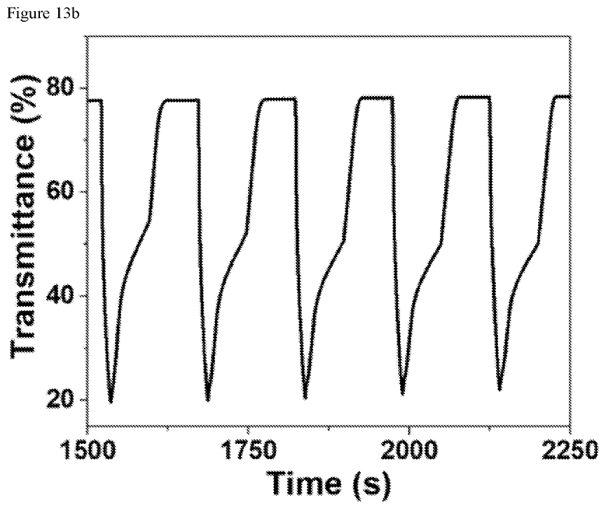

FIG. 13a is a graph showing the cycling test of a REM of Example 2b using quasi-solid-state solution at 550 nm in transmittance mode.

FIG. 13b is a graph showing the in-situ transmittance response of electrodeposition/dissolution of the Cu film on FTO electrode (550 nm) in a REM of Example 2b using quasi-solid-state solution.

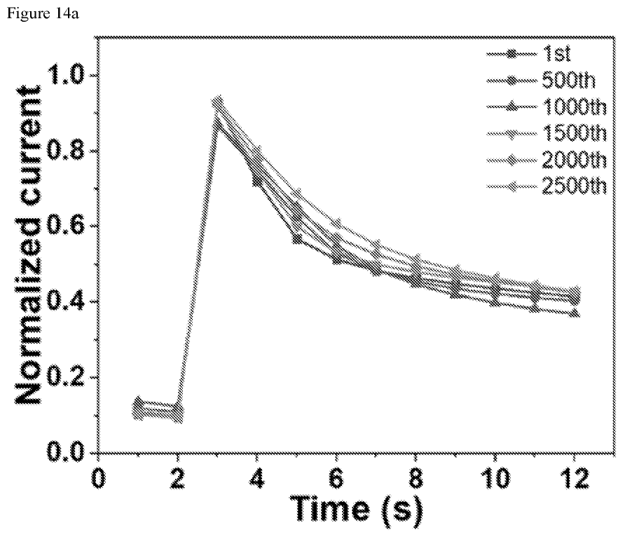

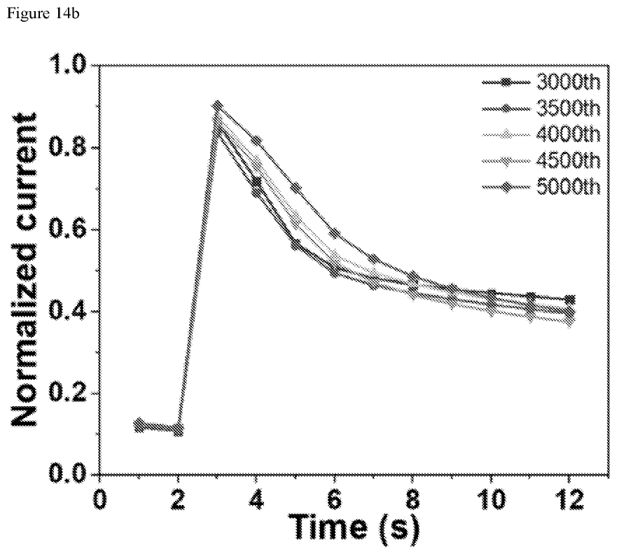

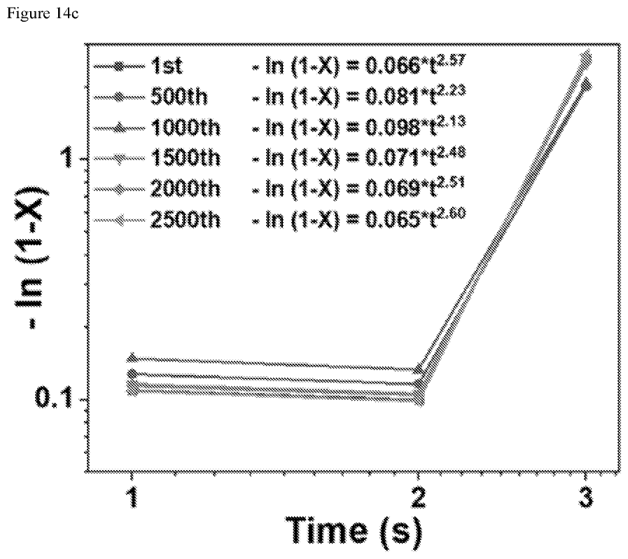

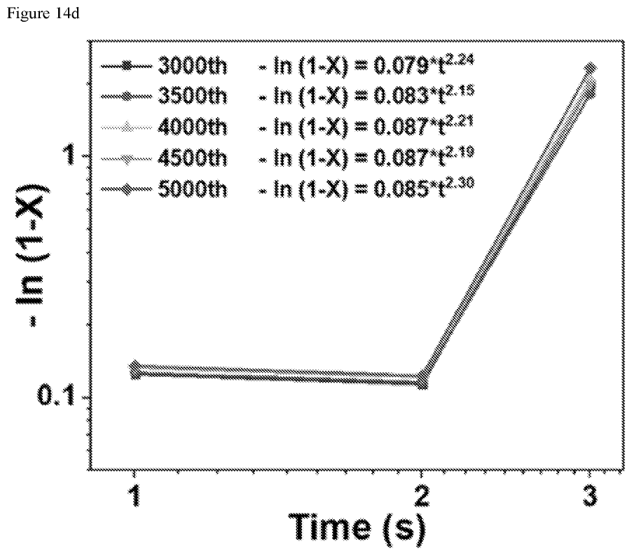

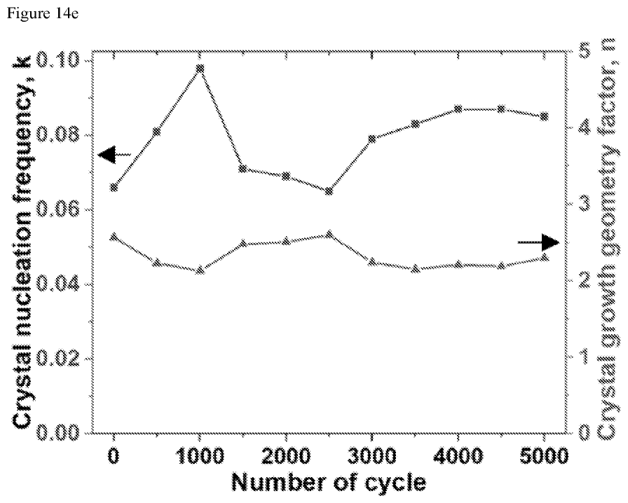

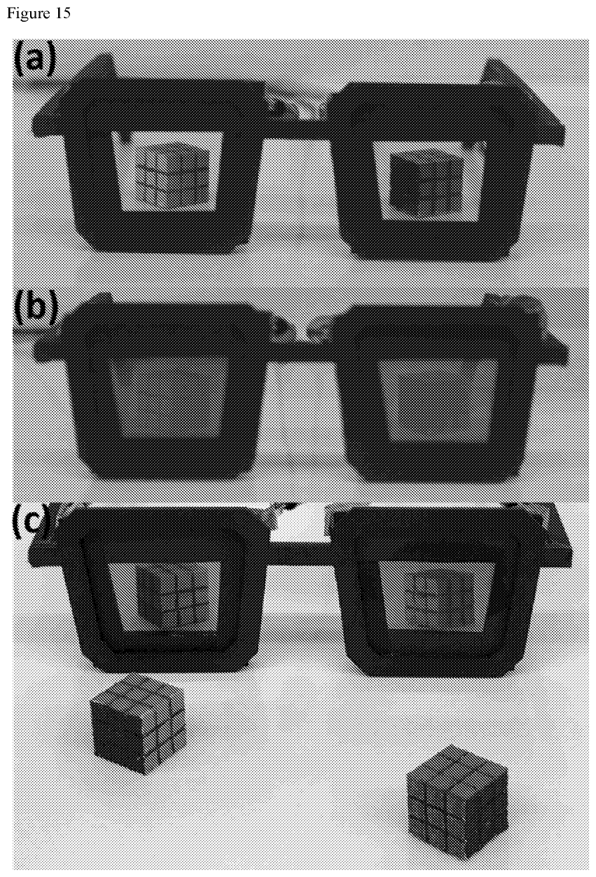

FIG. 14a is a graph showing the normalized current-time curves for electrodeposition at Cycles 1 to 2500. Three-electrode electrochemical cuvette testing was done according to Example 1f.

FIG. 14b is a graph showing the normalized current-time curves for electrodeposition at Cycles 3000 to 5000. Three-electrode electrochemical cuvette testing was done according to Example 1f.

FIG. 14c is a graph showing the double logarithmic plot derived from the current increase process at cycle numbers 1 to 2500.

FIG. 14d is a graph showing the double logarithmic plot derived from the current increase process at cycle numbers 3000 to 5000.

FIG. 14e is a graph showing the extracted values of k and n during the cycling process following JMAK analysis of hybrid electrolyte.

FIG. 15 is an image demonstrating a REM of Example 2a using hybrid electrolyte retrofitted into 3D-printed eyewear at the a) transparent state (no voltage), b) red colored state at −2.0 V for 5 minutes, c) mirror state at −3.5 V for 5 minutes.

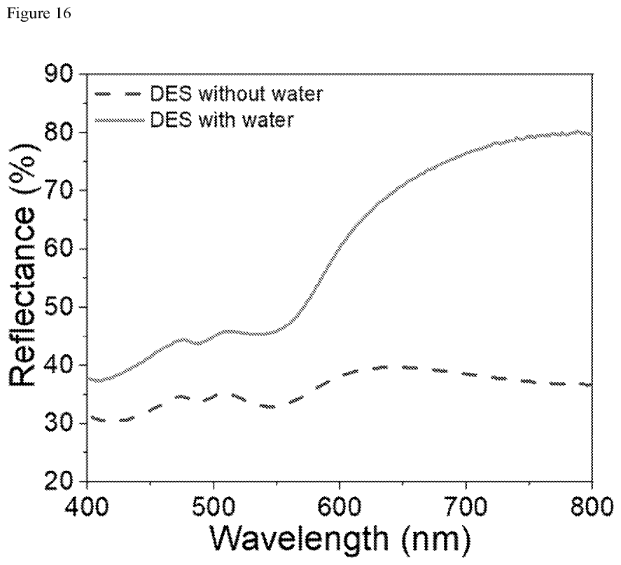

FIG. 16 is a spectrum showing the reflectance of Cu films electrodeposited from deep eutectic solvent (DES) electrolytes comprising choline chloride and glycerol, with and without water. Three-electrode electrochemical testing was done according to Example 1e.

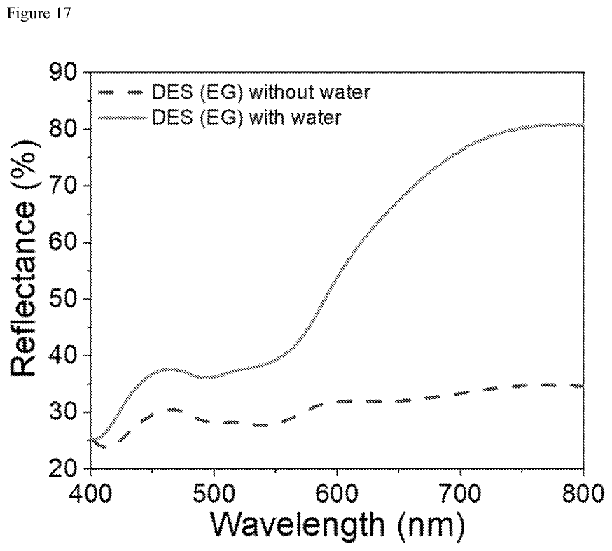

FIG. 17 is a spectrum showing the reflectance of Cu films electrodeposited from DES electrolytes comprising choline chloride and ethylene glycol, with and without water. Three-electrode electrochemical testing was done according to Example 1e.

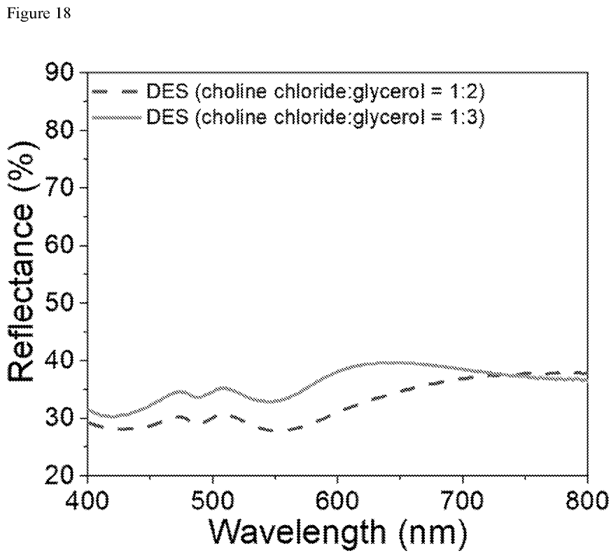

FIG. 18 is a spectrum showing the reflectance of Cu films electrodeposited from DES electrolytes at different DES component ratios. Three-electrode electrochemical testing was done according to Example 1e.

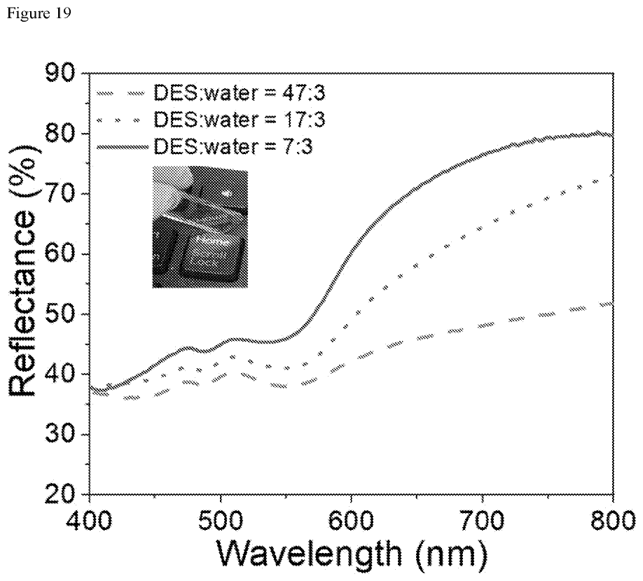

FIG. 19 is a spectrum showing the reflectance of Cu films electrodeposited from hybrid electrolytes with different ratios of deep eutectic solvent to water. Inset shows a highly reflective Cu film electrodeposited from the experiment. Three-electrode electrochemical testing was done according to Example 1e.

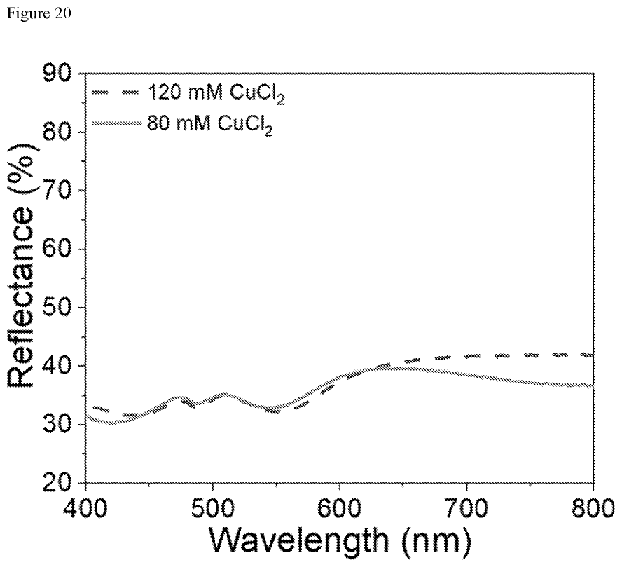

FIG. 20 is spectrum showing the reflectance of Cu films electrodeposited at different concentrations of electrochromic material in the REM. Three-electrode electrochemical testing was done according to Example 1e.

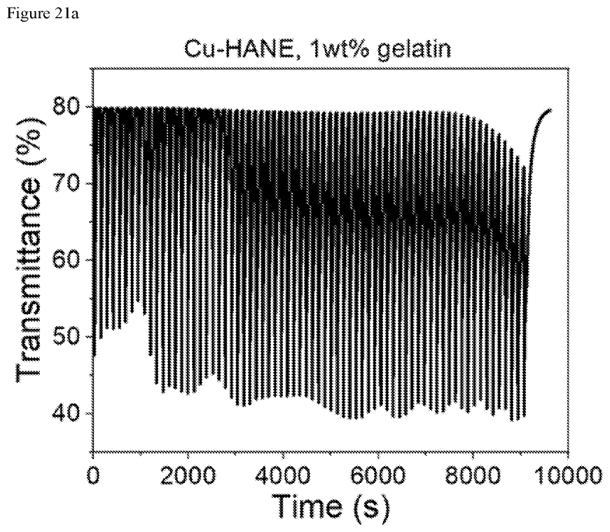

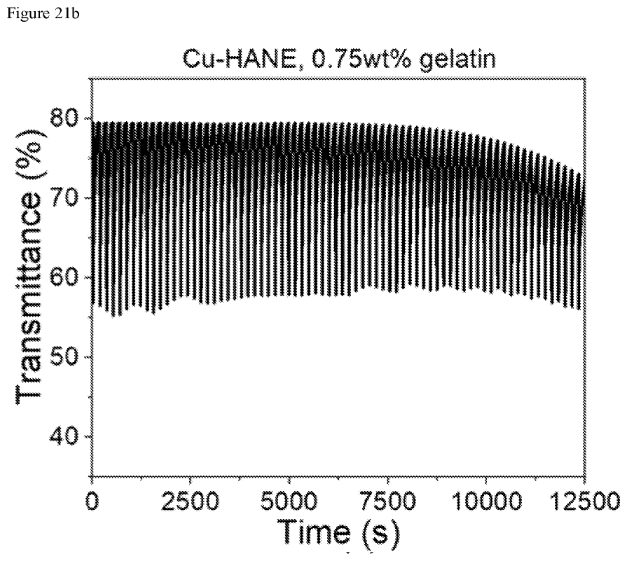

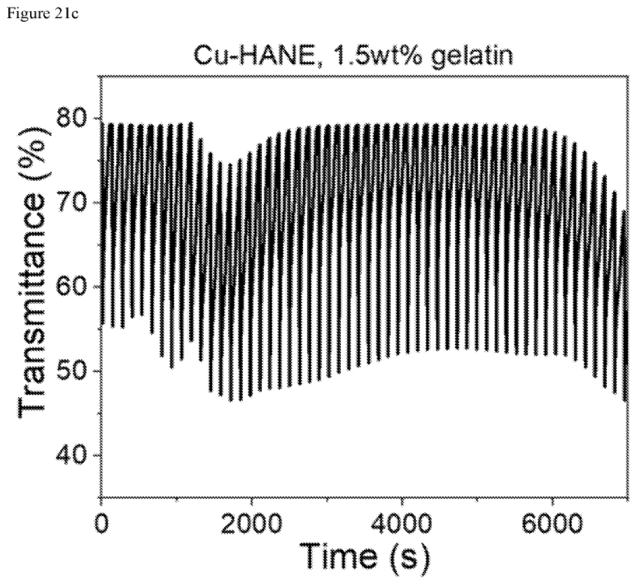

FIG. 21a is a graph showing the cycling stability of REM of Example 2b using hybrid electrolyte with 1 wt % of gelatin as polymer host.

FIG. 21b is a graph showing the cycling stability of REM of Example 2b using hybrid electrolyte with 0.75 wt % of gelatin as polymer host.

FIG. 21c is a graph showing the cycling stability of REM of Example 2b using hybrid electrolyte with 1.5 wt % of gelatin as polymer host.

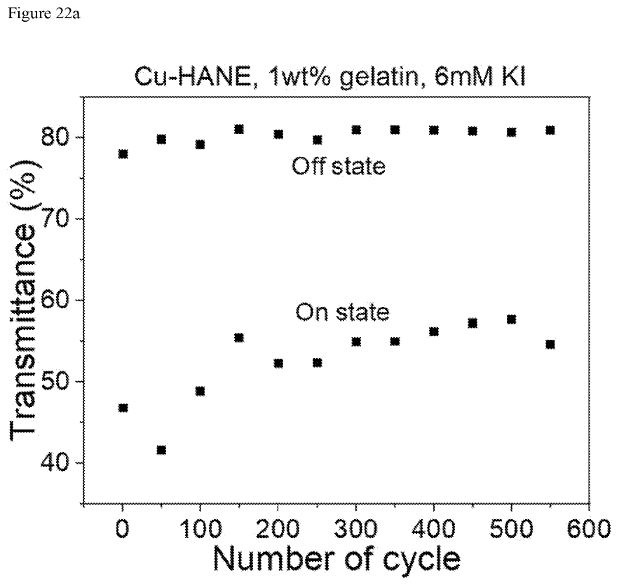

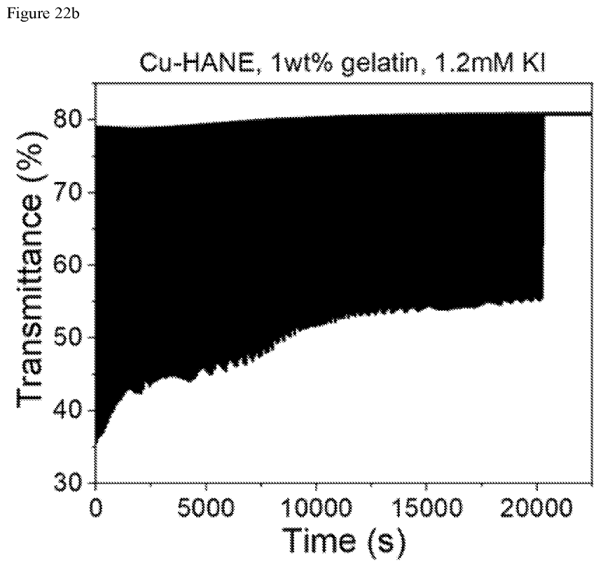

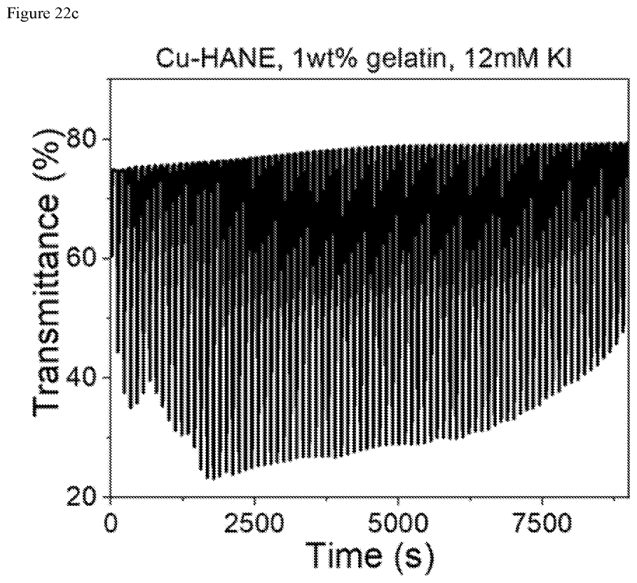

FIG. 22a is a graph showing the cycling stability of REM of Example 2b using hybrid electrolyte at 6 mM of the electrochemical mediator.

FIG. 22b is a graph showing the cycling stability of REM of Example 2b using hybrid electrolyte at 1.2 mM of electrochemical mediator.

FIG. 22c is a graph showing the cycling stability of REM of Example 2b using hybrid electrolyte at 12 mM of electrochemical mediator.

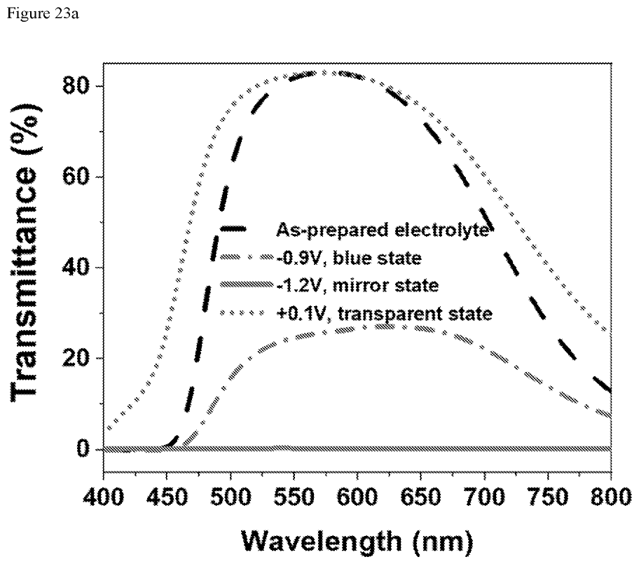

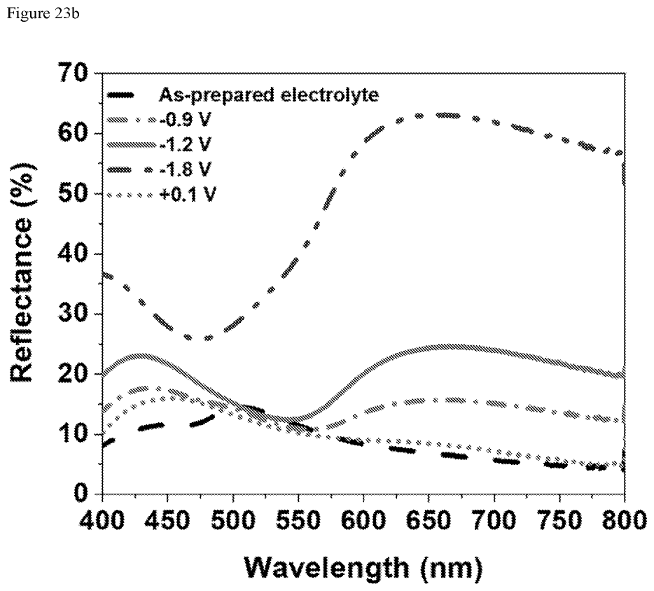

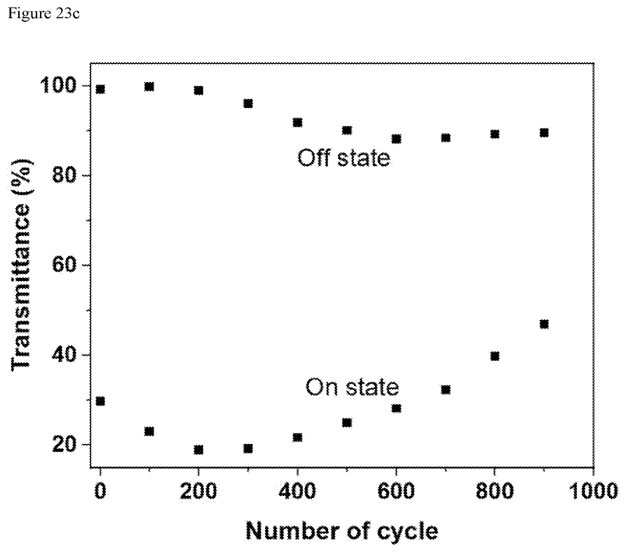

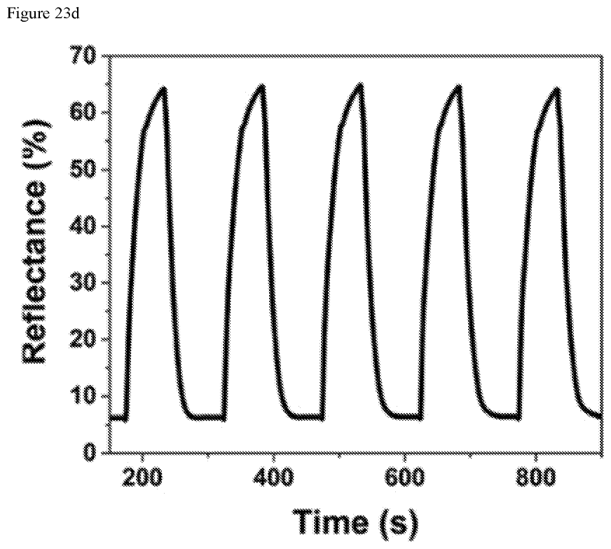

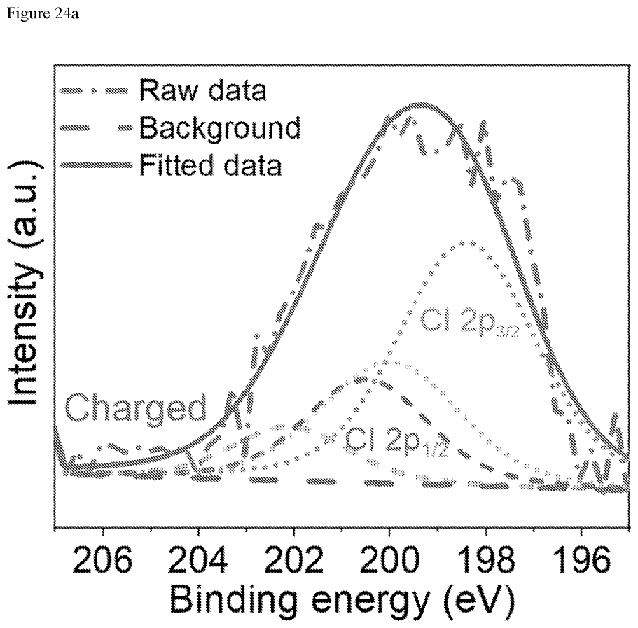

FIG. 23a is a graph showing the transmittance spectra of Cu electrodeposited on an electrode in a REM of Example 2b, except that DMSO-based electrolyte is used.

FIG. 23b is a graph showing the reflectance spectra of Cu electrodeposited on an electrode in a REM of Example 2b, except that DMSO-based electrolyte is used.

FIG. 23c is a graph showing the cycling performance using three-electrode electrochemical cuvette testing of REM electrolyte of Example 1f, except that DMSO-based electrolyte is used.

FIG. 23d is a graph showing the in situ reflectance response of a REM of Example 2b, except that a DMSO-based electrolyte is used.

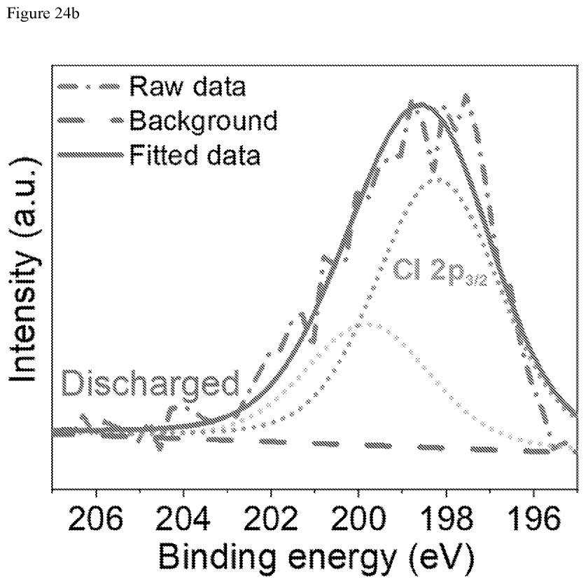

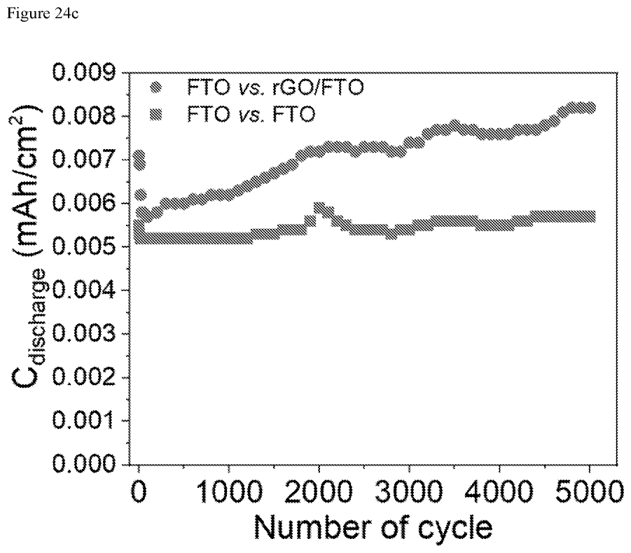

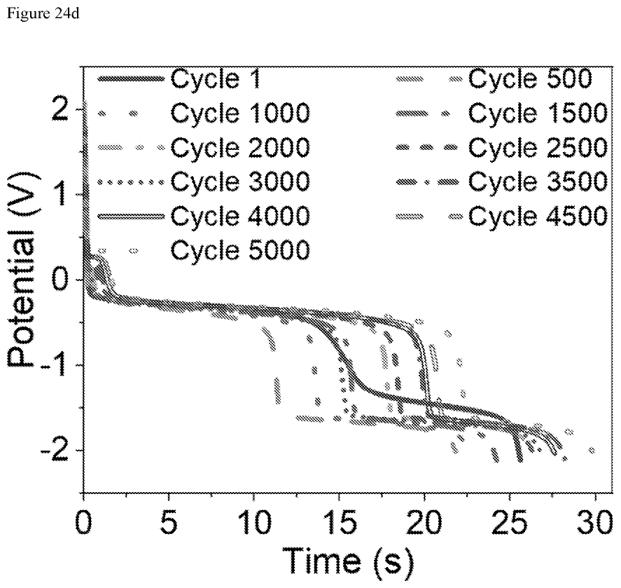

FIG. 24a is a graph showing the X-Ray photoelectron spectroscopy (XPS) spectrum of Cl 2p in rGO/FTO electrode at a charged state.

FIG. 24b is a graph showing the X-Ray photoelectron spectroscopy (XPS) spectrum of Cl 2p in rGO/FTO electrode at a discharged state.

FIG. 24c is a graph showing the cycling retention curves of the REM battery full cell testing at 1 mA cm⁻². Two-electrode electrochemical testing was done according to Example 1c.

FIG. 24d is a graph showing the galvanostatic discharge curves at 1 mA cm⁻¹ for the Cu hybrid/rGO REM battery at different cycle numbers. Two-electrode electrochemical testing was done according to Example 1c.

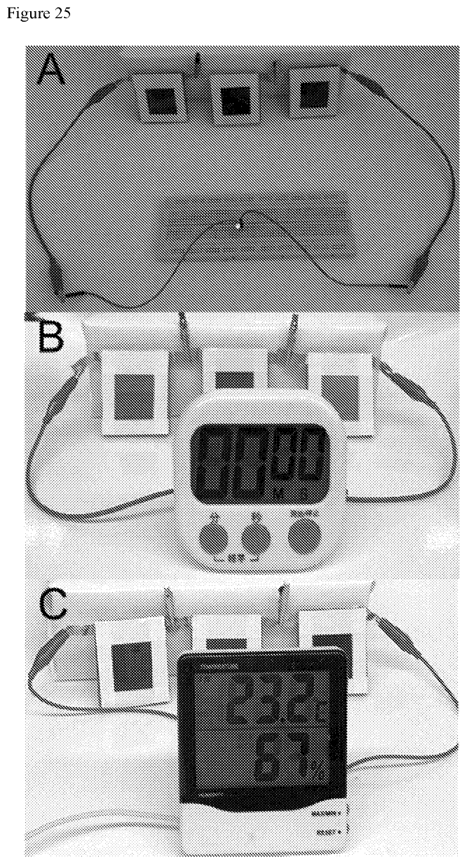

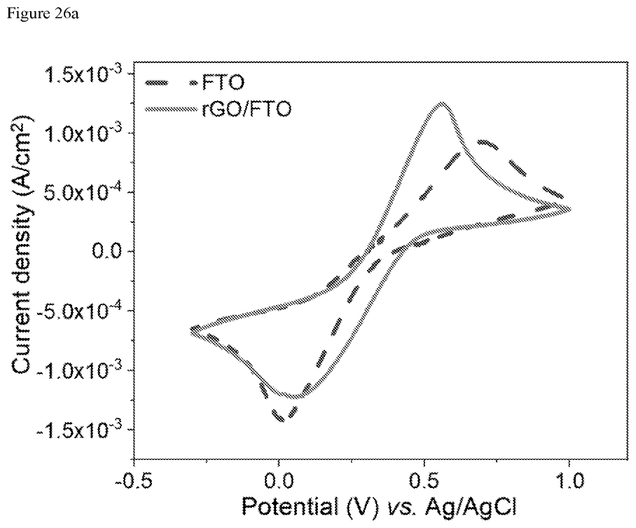

FIG. 25 are photographs demonstrating three small devices (Example 2a) using hybrid electrolyte connected in series to power the (A) red LED indicator, (B) timer, and (C) temperature and humidity sensor.

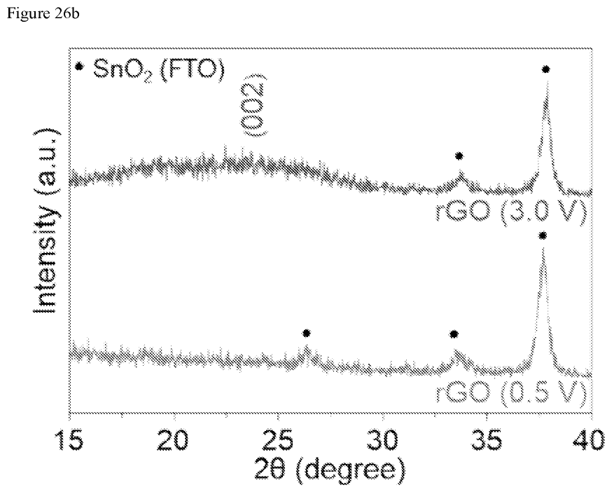

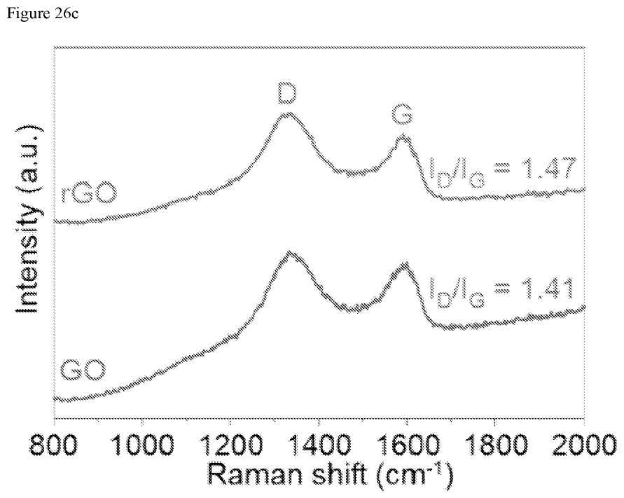

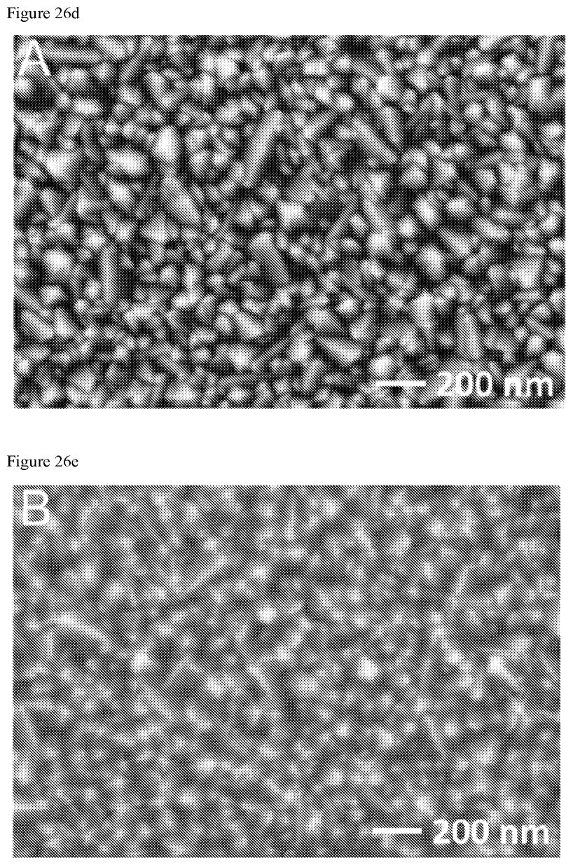

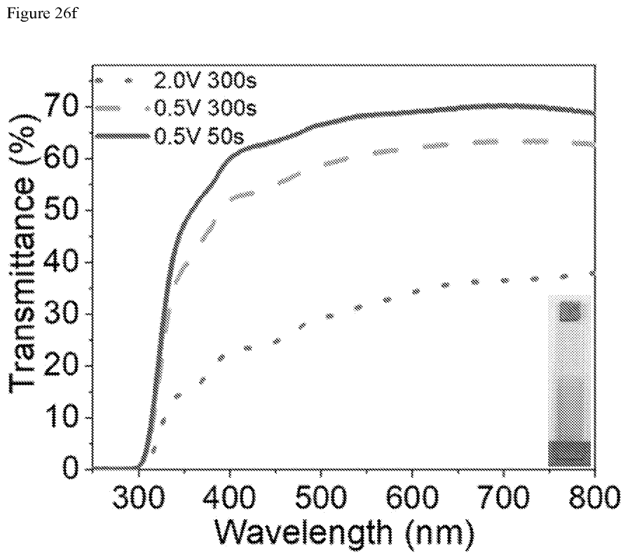

FIG. 26a is a graph showing the cyclic voltammograms of bare FTO and rGO/FTO electrodes in hybrid electrolyte scanned at a scan rate of 5 mV s⁻¹ (vs Ag/AgCl, with Pt as the counter electrode, using two-electrode electrochemical testing according to Example 1e).

FIG. 26b is a graph showing the X-Ray Diffraction (XRD) diffraction patterns of the as-prepared rGO/FTO electrode.

FIG. 26c is a graph showing the Raman spectrum of GO and rGO on the FTO electrode.

FIG. 26d is a photograph showing the Scanning Electron Microscopy (SEM) image of bare FTO electrode.

FIG. 26e is a photo showing the Scanning Electron Microscopy (SEM) image of rGO/FTO electrode (EPD at +0.5 V 50 s and annealed).

FIG. 26f is a graph showing the transmittance spectra of the rGO/FTO electrode at various wavelengths. The inset is the image of the rGO/FTO electrode (electrophoretic deposition of GO at +0.5 V for 50 s and annealed at 200° C. in Ar gas).

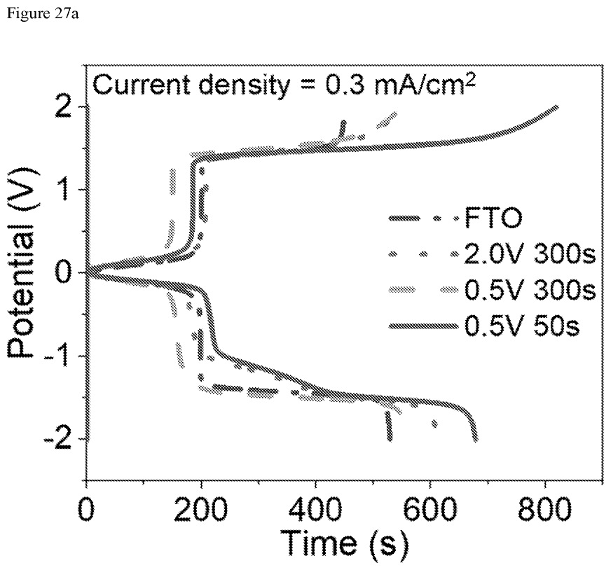

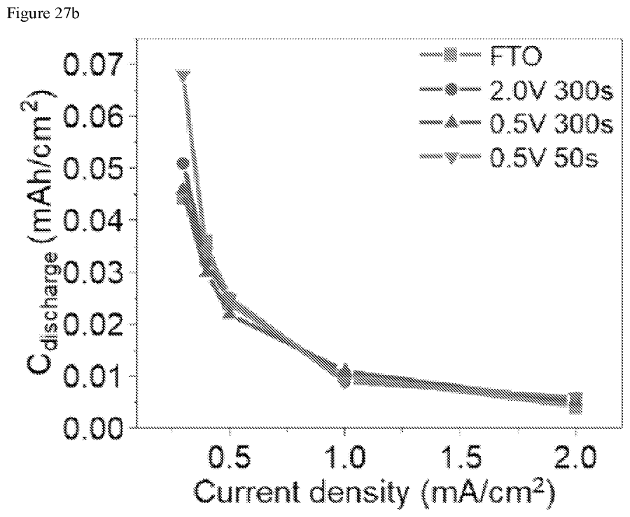

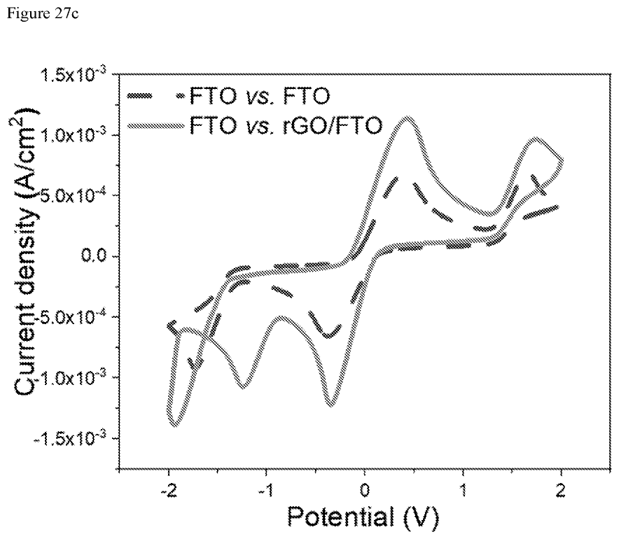

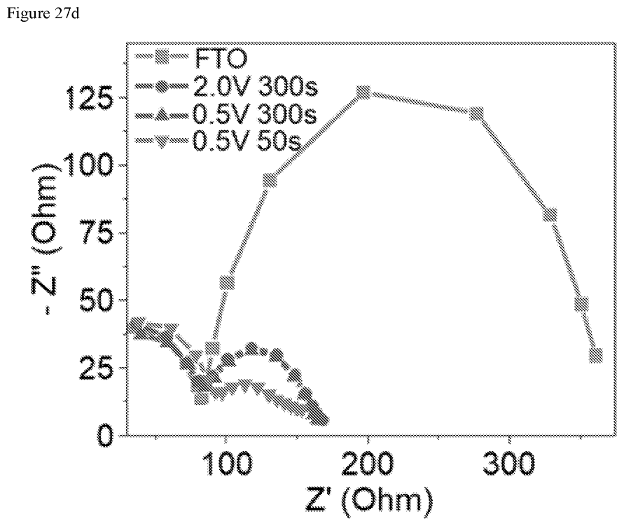

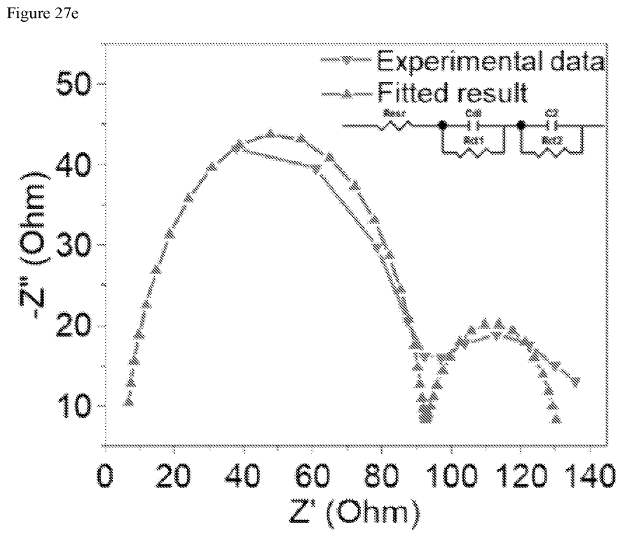

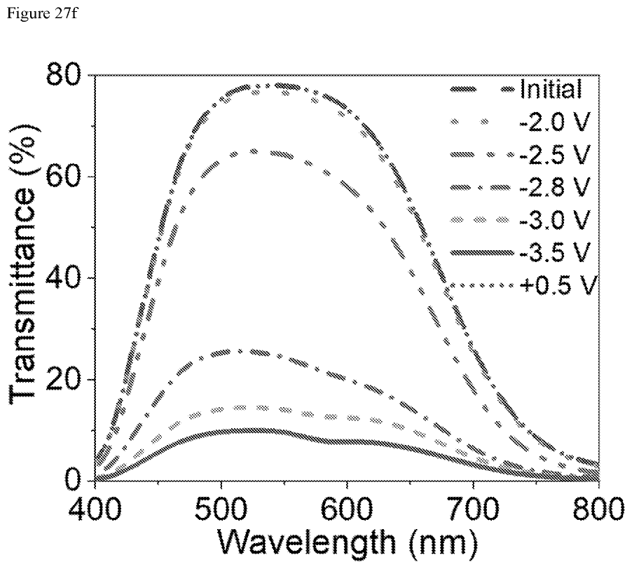

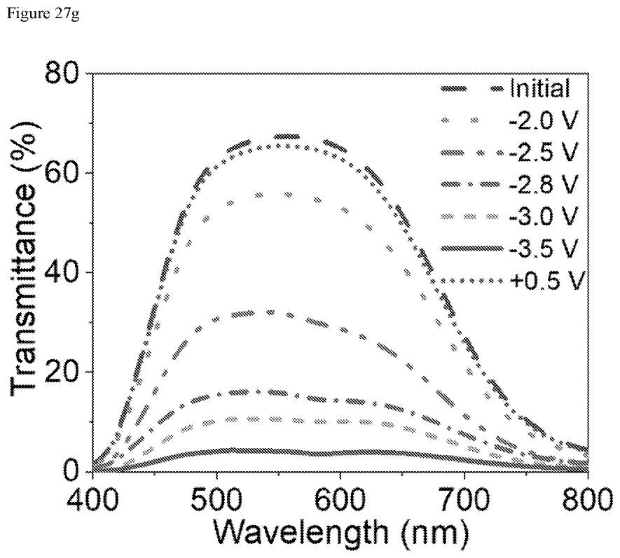

FIG. 27a is a graph showing the galvanostatic charge discharge (GCD) curves at 0.3 mA cm⁻¹ of the REM battery under different conditions. Two-electrode electrochemical testing was done according to Example 1c.

FIG. 27b is a graph showing the electrochemical performance of REM battery as a function of the current density. Two-electrode electrochemical testing was done according to Example 1c.

FIG. 27c is a graph showing the cyclic voltammogram of the REM battery (FTO vs. FTO and FTO vs. optimized rGO/FTO). Two-electrode electrochemical testing was done according to Example 1c.

FIG. 27d is a graph showing the Nyquist plot of the FTO and rGO/FTO samples in the hybrid electrolyte. Three-electrode electrochemical testing was done according to Example 1e.

FIG. 27e is a graph showing the fitted Electrochemical Impedance Spectroscopy (EIS) spectra obtained by the ZView software using the experimental data. The inset shows the equivalent circuit used to model the EIS data of the optimized rGO/FTO sample in the hybrid electrolyte as determined by the ZView software. Three-electrode electrochemical testing was done according to Example 1e.

FIG. 27f is a graph showing the in situ transmittance spectra of the hybrid electrolyte in the REM battery at different voltages. Two-electrode electrochemical cuvette testing was done according to Example 1d.

FIG. 27g is a graph showing the in situ transmittance spectra of the hybrid electrolyte in the hybrid/rGO REM battery at different voltages. Two-electrode electrochemical cuvette testing was done according to Example 1d.

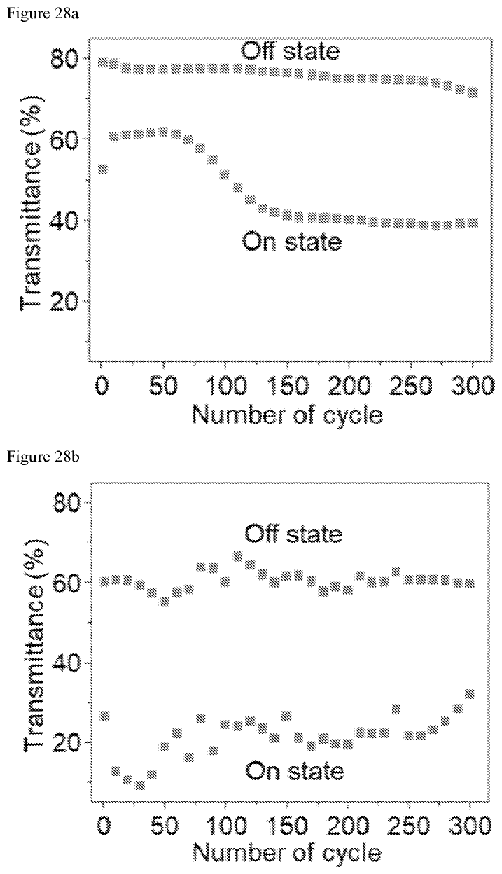

FIG. 28a is a graph showing the cycling performance of the REM battery and using voltage algorithm VA3 at 550 nm in the transmittance mode. Two-electrode electrochemical cuvette testing was done according to Example 1d.

FIG. 28b is a graph showing the cycling performance of the Cu hybrid/rGO REM battery using voltage algorithm VA3 at 550 nm in the transmittance mode. Two-electrode electrochemical cuvette testing was done according to Example 1d.

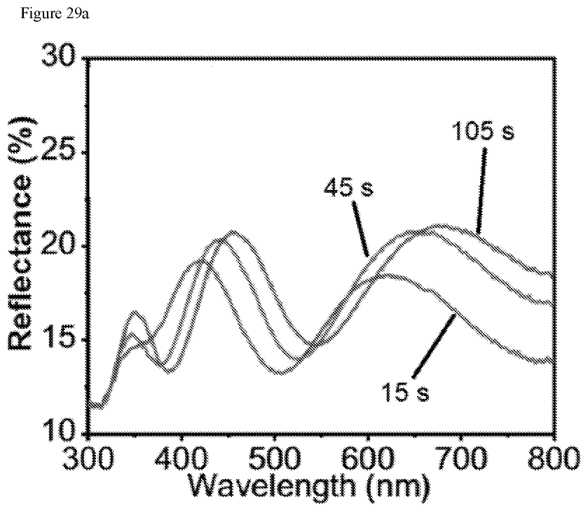

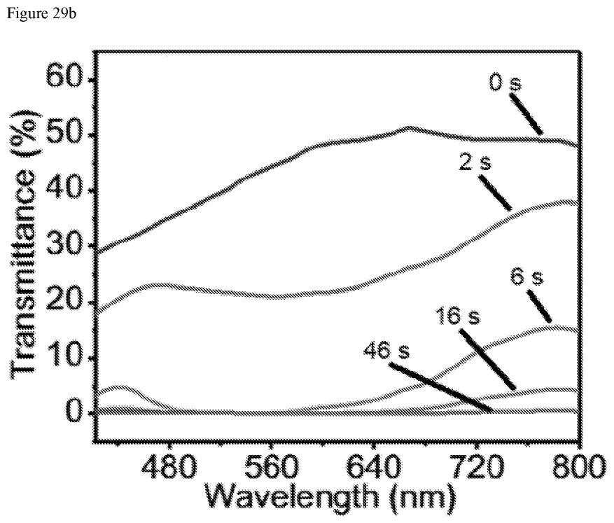

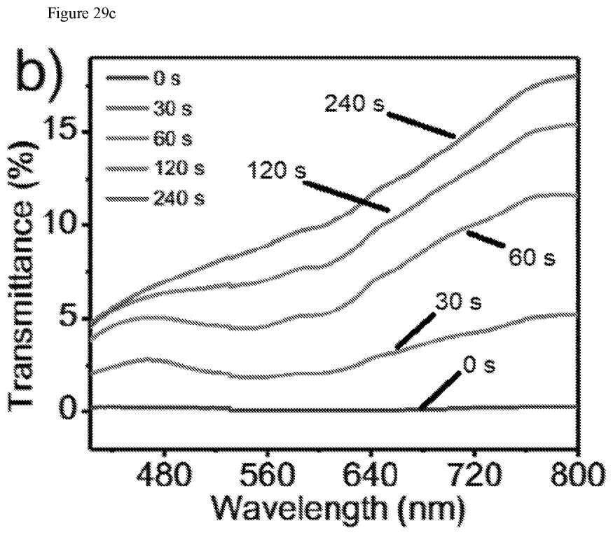

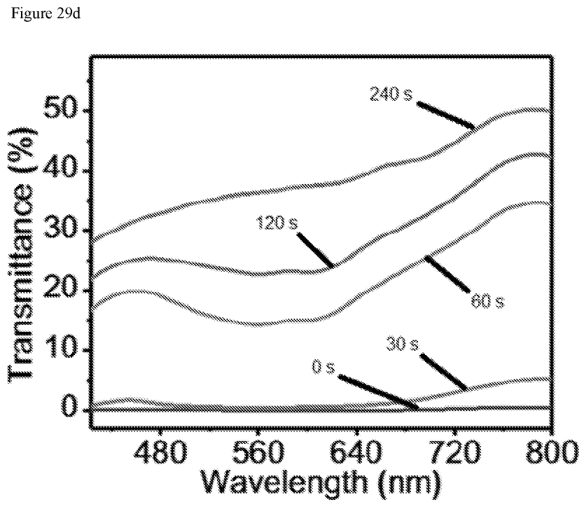

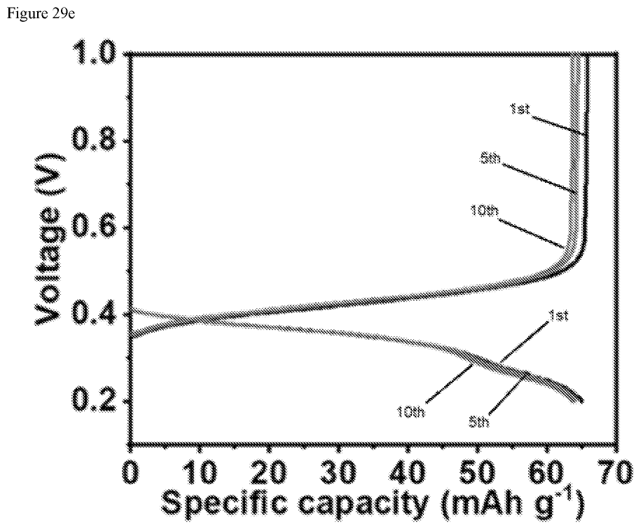

FIG. 29a is a graph showing the reflectance spectra for glass-Zn-REM after being charged at various durations.

FIG. 29b is a graph showing the transmittance spectra of glass-Zn-REM during a first discharging process at a reverse voltage of 0.5 V, with Zn foil without Zn electrodeposition

FIG. 29c is a graph showing the transmittance spectra of glass-Zn-REM during a first charging process at 1.0 V.

FIG. 29d is a graph showing the transmittance spectra of glass-Zn-REM during a first charging process at 1.0 V, where half of the ITO glass was insulated to avoid electrodeposition and to allow UV-Vis radiation to pass through.

FIG. 29e is a graph showing the charge-discharge potential vs capacity curves and the cycling performance of glass-Zn-REM at a current density of 0.01 A g⁻¹ (based on the weight of V²⁺) in the range of 0.2-1.2 V in the first cycle.

### DETAILED DISCLOSURE OF EMBODIMENTS

The present invention relates to a reversible electrochemical mirror (REM) comprising a hybrid electrolyte and metal salt.

The hybrid electrolyte comprises an aqueous electrolyte with non-aqueous electrolyte. With the hybridization approach, this hybrid electrolyte advantageously inherits the merits of a wide electrochemical voltage window and shows enhancement in the current efficiency besides the non-toxicity and non-flammability characteristics. As the electrolyte used in the present invention comprises both an aqueous solvent and a deep eutectic solvent, fine tuning of the electrolyte is possible to adjust the redox peak of the metal used. This advantageously results in high-performing electrolytes that can work with any combinations of deep eutectic solvents, aqueous solvents, metal salts, polymer host, electrochemical mediators or combinations thereof.

An advantage of the present REM is that it allows the controllable tailoring of the redox peak positioning of the metal used. For instance, a cathodic peak shift to higher reduction potential can promote the electrochemical reduction of metal (ease of mirror film formation) and an anodic peak shift to lower oxidation potential can promote electrochemical oxidation of metal, resulting in ease of film dissolution.

The hybrid electrolyte of the present invention which contains a metal salt may possess an ionic conductivity comparable to the ionic conductivity of the same metal salt in an aqueous electrolyte, about 25% to about 85%, about 35% to about 85%, about 45% to about 85%, about 55% to about 85%, about 65% to about 85%, about 75% to about 85%, about 25% to about 75%, about 35% to about 75%, about 45% to about 75%, about 55% to about 75%, about 65% to about 75%, about 25% to about 65%, about 35% to about 65%, about 45% to about 65%, about 55% to about 65%, about 25% to about 55%, about 35% to about 55%, about 45% to about 55%, about 25% to about 45%, about 35% to about 45%, about 25% to about 35%, about 25%, about 35%, about 45%, about 55%, about 65%, about 75%, about 85%, at least about 25%, at least about 35%, at least about 45%, at least about 55%, at least about 65%, at least about 75%, or any values or range therebetween.

Additionally, the hybrid electrolyte of the present invention which contains a metal salt may possess an ionic conductivity that is superior to the ionic conductivity of the same metal in pure deep eutectic solvent electrolytes. The improved ionic conductivity may be in a range of about 1 to about 5 orders higher, about 2 orders to about 5 orders higher, about 3 orders to about orders higher, about 4 orders to about 5 orders higher, about 1 order to about 4 orders higher, about 2 orders to about 4 orders higher, about 3 orders to about 4 orders higher, about 1 order to about 3 orders higher, about 2 orders to about 3 orders higher, about 1 order to about 2 orders higher, about 1 order higher, about 2 orders higher, about 3 orders higher, about 4 orders higher, about 5 orders higher, at least about 1 order higher, at least about 2 orders higher, at least about 3 orders higher, at least about 4 orders higher, at least about 5 orders higher, or any values or range therebetween.

In an embodiment, the present invention relates to a reversible electrochemical mirror (REM) comprising an electrolytic solution, wherein the electrolytic solution comprises a deep eutectic solvent, at least about 20 wt % aqueous solvent based on the total weight of deep eutectic solvent and aqueous solvent, and a metal salt.

The REM of the present invention may exhibit reversible electrodeposition and dissolution process upon the application of electrical bias. Accordingly, the REM may be used to actively control both the transmission and reflection of light. The REM can be electrochemically tuned to achieve dual transmittance and reflectance modulations in a single device. Additionally, the hybrid electrolyte demonstrates the ability to tailor the redox peak positioning, which promotes the electrochemical activity of metal. With favorable electrochemical behaviors, the hybrid electrolyte may demonstrate robust cycling stability, fast coloration speed and bleaching speed, as well as excellent Coulombic efficiency.

The REM of the present invention may advantageously function without prior deposition of electrochromic material on the transparent conductive electrode. Such methods that are required in conventional REM devices include high-vacuum sputtering, electrodeposition, spray-coating, inkjet-printing, etc. This is a surprising advantage of the REM of the present invention, simplifying the manufacturing process, while at the same time still maintaining a higher performance than conventional REM devices.

Any deep eutectic solvent (DES) may be used in the reversible electrochemical mirror (REM) of the present invention. DESs are acknowledged as a category of ionic liquids analogues that share several similar physical properties with classic ionic liquids, such as tunable solvents, and low vapor pressure.

In some embodiments the aqueous solvent may be any solvent that is miscible with water. In other embodiments the aqueous solvent is water. In further embodiments the water may be neutral in pH, acidic, or basic.

The REM of the present invention is also capable of operating at various weight percentages of aqueous solvent (such as water) in the hybrid electrolyte. The electrolytic solution may comprise or consist of at least about 6 wt % aqueous solvent based on the total weight of deep eutectic solvent and aqueous solvent, or at least about 10 wt %, at least about 15 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 94 wt %, or any value or range therebetween. The electrolytic solution may comprise or consist of aqueous solvent (based on the total weight of deep eutectic solvent and aqueous solvent) in a range of about 6 wt % to about 94 wt %, about 10 wt % to about 94 wt %, about 15 wt % to about 94 wt %, about 20 wt % to about 94 wt %, about 26 wt % to about 94 wt %, about 35 wt % to about 94 wt %, about 45 wt % to about 94 wt %, about 55 wt % to about 94 wt %, about 65 wt % to about 94 wt %, about 75 wt % to about 94 wt %, about 85 wt % to about 94 wt %, about 6 wt % to about 85 wt %, about 10 wt % to about 85 wt %, about 15 wt % to about 85 wt %, about 20 wt % to about 85 wt %, about 26 wt % to about 85 wt %, about 35 wt % to about 85 wt %, about 45 wt % to about 85 wt %, about 55 wt % to about 85 wt %, about 65 wt % to about 85 wt %, about 75 wt % to about 85 wt %, about 6 wt % to about 75 wt %, about 10 wt % to about 75 wt %, about 15 wt % to about 75 wt %, about 20 wt % to about 75 wt %, about 26 wt % to about 75 wt %, about 35 wt % to about 75 wt %, about 45 wt % to about 75 wt %, about 55 wt % to about 75 wt %, about 65 wt % to about 75 wt %, about 6 wt % to about 65 wt %, about 10 wt % to about 65 wt %, about 15 wt % to about 65 wt %, about 20 wt % to about 65 wt %, about 26 wt % to about 65 wt %, about 35 wt % to about 65 wt %, about 45 wt % to about 65 wt %, about 55 wt % to about 65 wt %, about 6 wt % to about 55 wt %, about 10 wt % to about 55 wt %, about 15 wt % to about 55 wt %, about 20 wt % to about 55 wt %, about 26 wt % to about 55 wt %, about 35 wt % to about 55 wt %, about 45 wt % to about 55 wt %, about 6 wt % to about 45 wt %, about 10 wt % to about 45 wt %, about 15 wt % to about 45 wt %, about 20 wt % to about 45 wt %, about 26 wt % to about 45 wt %, about 35 wt % to about 45 wt %, about 6 wt % to about 35 wt %, about 10 wt % to about 35 wt %, about 15 wt % to about 35 wt %, about 20 wt % to about 35 wt %, about 26 wt % to about 35 wt %, about 6 wt % to about 26 wt %, about 10 wt % to about 26 wt %, about 15 wt % to about 26 wt %, about 20 wt % to about 26 wt %, about 6 wt % to about 20 wt %, about 10 wt % to about 20 wt %, about 15 wt % to about 20 wt %, about 6 wt % to about 15 wt %, about 10 wt % to about 15 wt %, about 6 wt %, about 10 wt %, about 15 wt %, about 20 wt %, about 26 wt %, about 35 wt %, about 45 wt %, about 55 wt %, about 65 wt %, about 75 wt %, about 85 wt %, about 94 wt %, or any ranges or values therebetween. In an embodiment, the electrolytic solution may contain (based on the total weight of deep eutectic solvent and aqueous solvent) about 26 wt % of aqueous solvent.

The weight ratio of the deep eutectic solvent to aqueous solvent may be in the range of about 4:1 (80:20) to about 3:47 (6:94), about 75:25 to about 3:47 (6:94), about 70:30 to about 3:47 (6:94), about 65:35 to about 3:47 (6:94), about 60:40 to about 3:47 (6:94), about 55:45 to about 3:47 (6:94), about 50:50 to about 3:47 (6:94), about 45:55 to about 3:47 (6:94), about 40:60 to about 3:47 (6:94), about 35:65 to about 3:47 (6:94), about 30:70 to about 3:47 (6:94), about 25:75 to about 3:47 (6:94), about 20:80 to about 3:47 (6:94), about 15:85 to about 3:47 (6:94), about 10:90 to about 3:47 (6:94), about 10:90 to about 3:47 (6:94), about 4:1 (80:20) to about 10:90, about 4:1 (80:20) to about 15:85, about 4:1 (80:20) to about 20:80, about 4:1 (80:20) to about 25:75, about 4:1 (80:20) to about 30:70, about 4:1 (80:20) to about 35:65, about 4:1 (80:20) to about 40:60, about 4:1 (80:20) to about 45:55, about 4:1 (80:20) to about 50:50, about 4:1 (80:20) to about 55:45, about 4:1 (80:20) to about 60:40, about 4:1 (80:20) to about 65:35, about 4:1 (80:20) to about 70:30, about 4:1 (80:20) to about 75:25, or about 4:1 (80:20), about 75:25, about 70:30, about 65:35, about 60:40, about 55:45, about 50:50, about 45:55, about 40:60, about 35:65, about 30:70, about 25:75, about 20:80, about 15:85, about 10:90, about 3:47 (6:94), or any value or range therebetween.

Any deep eutectic solvent may be used to form the reversible electrochemical mirror of the present invention. The components in the deep eutectic solvent (DES) may be broadly classified as comprising a hydrogen bond acceptor (for example, ionic species) and a hydrogen bond donor. The DES may be selected from a group consisting of a Type I deep eutectic solvent made up of a quaternary ammonium salt and a metal chloride, a Type II deep eutectic solvent made up of a quaternary ammonium salt and a metal chloride hydrate, a type III deep eutectic solvent made up of a quaternary ammonium salt and a hydrogen bond donor, a type IV deep eutectic solvent made up of a metal chloride hydrate and a hydrogen bond donor, or any combinations thereof. Accordingly, the deep eutectic solvent in the REM of the present invention may comprise a hydrogen bond acceptor (for example, ionic species) and a hydrogen bond donor.

The REM of the present invention may be capable of functioning at different component ratios of the deep eutectic solvent (DES). In an embodiment, the deep eutectic solvent comprises an ionic species and hydrogen bond donor. The weight ratio of the ionic species to the hydrogen bond donor may be in a range of about 1:1 to about 1:5, about 45:55 to about 1:5, about 40:60 to about 1:5, about 35:65 to about 1:5, about 1:3 to about 1:5, about 30:70 to about 1:5, about 25:75 to about 1:5, about 20:80 to about 1:5, about 1:1 to about 20:80, about 1:1 to about 25:75, about 1:1 to about 30:70, about 1:1 to about 35:65, about 1:1 to about 40:60, about 1:1 to about 45:55, or about 1:1, about 45:55, about 40:60, about 35:65, about 1:2, about 30:70, about 25:75, about 20:80, about 1:5, or any range of values therebetween. In a preferred embodiment, the weight ratio of the ionic species to the hydrogen bond donor is 1:3.

In an embodiment, the hybrid electrolyte may comprise Type III eutectics, which can be prepared from choline chloride and hydrogen bond donors, with the capability to solvate an extensive range of transition metal species that include oxides and chlorides. This is particularly impactful as DESs can facilitate the electrodeposition of metal coatings without presence of toxic co-ligand such as cyanide. Choline chloride, a provitamin, is widely used for chicken feed and is produced as an animal feed supplement on the megaton scale. Choline chloride is a quaternary ammonium salt that can form low-melting eutectic mixtures with various hydrogen bond donor compounds, such as ethylene glycol, glycerol, urea, acetamide, citric acid, and malonic acid. Glycerol is generally regarded as a green solvent as it is known to be biodegradable, non-toxic, non-flammable, and renewable. In one embodiment, the preparation of DES for the hybrid electrode only requires the simple mixing of the two components (choline chloride and glycerol) with moderate heating. Such facile processing permits large scale production with low cost compared to the classic ionic liquids (imidazolium type). DESs display significant advantage over classic ionic liquids as they are biodegradable, air and moisture stable, with ubiquitous availability, ease of preparation and thus, economically viable to large-scale processes.

Accordingly, in a preferred embodiment, the present invention discloses an REM where the deep eutectic solvent is a Type III deep eutectic solvent comprising a quaternary ammonium salt and a hydrogen bond donor.

The ionic species used to form the deep eutectic solvent may comprise quaternary ammonium salt, choline salt, choline chloride, choline bromide, choline acetate, chlorocholine chloride, lithium chloride, lithium acetate, lithium perchlorate, lithium triflate, lithium bistriflimide, lithium trifluoromethanesulfonate, lithium bis(trifluoromethanesulfonyl)imide, sodium chloride, sodium acetate, sodium perchlorate, sodium triflate, sodium bistriflimide, sodium trifluoromethanesulfonate, sodium bis(trifluoromethanesulfonyl)imide, potassium chloride, potassium acetate, potassium perchlorate, potassium triflate, potassium bistriflimide, potassium trifluoromethanesulfonate, potassium bis(trifluoromethanesulfonyl)imide, tetrabutylammonium trifluoromethane sulfonate, tetrabutylammonium chloride, tetrabutylammonium bromide, tetramethylammonium chloride, tetramethylammonium bromide, N-ethyl-2-hydroxy-N,N-dimethylethanaminium chloride, 2-(chlorocarbonyloxy)-N,N,N-trimethylethanaminium chloride, N-benzyl-2-hydroxy-N,N-dimethylethanaminium chloride, or combinations thereof. In a preferred embodiment, the ionic species is choline chloride.

The hydrogen bond donor used to form the deep eutectic solvent may comprise ethylene glycol, polyethylene glycol, urea, 1-methyl urea, 1,1-dimethyl urea, 1,3-dimethyl urea, thiourea, acetamide, benzamide, citric acid, malonic acid, benzoic acid, adipic acid, oxalic acid, succinic acid, glycerol, or combinations thereof. In a preferred embodiment, the hydrogen bond donor is glycerol, ethylene glycol, or combinations thereof.

The REM may be formed using any reducible metal ion as the electrochromic material. The metal of the metal salt in the REM may comprise gold, silver, bismuth, lead, tin, nickel, iron, zinc, chromium, manganese, cobalt, palladium, cadmium, antimony, platinum, aluminum, magnesium, copper, or alloys or combinations thereof. The metal salt used to form the REM may comprise any anion. The anion of the metal salt may comprise chloride, sulfate, nitrate, perchlorate, iodide, acetate, and phosphate. In a preferred embodiment, the metal salt is copper(II) chloride.

The inventors have also advantageously discovered that the REM of the present invention possesses unexpected electrochromic properties even when the electrolyte does not possess any lithium, sodium or potassium salts. Such salts are often required to enhance the ionic conductivity of conventional electrolytes. In view of the high ionic conductivity of the REM disclosed herein, no additional ionic salt is required or used. As such, it is a surprising advantage of the present invention that the REM can function without any of the mentioned salts, often required in conventional electrolytes.

Additionally, the REM of the present invention may advantageously exhibit at least two states—(1) a transparent state when no voltage is applied, (2) a mirror state when the reduction voltage is applied to achieve the zero valence state. The REM device of the present invention may further advantageously exhibit a third state—(3) a colored, tinted, or semi-transparent state when a voltage is applied around the intermediate cathodic redox peak when metal salts comprise metals with multiple oxidation states are used.

The concentration of the metal salt in the electrolytic solution may be in the range of about 20 mM to about 2000 mM, about 50 mM to about 2000 mM, about 80 mM to about 2000 mM, about 100 mM to about 2000 mM, about 120 mM to about 2000 mM, about 200 mM to about 2000 mM, about 400 mM to about 2000 mM, about 600 mM to about 2000 mM, about 800 mM to about 2000 mM, about 1000 mM to about 2000 mM, about 1500 mM to about 2000 mM, about 20 mM to about 1500 mM, about 50 mM to about 1500 mM, about 80 mM to about 1500 mM, about 100 mM to about 1500 mM, about 120 mM to about 1500 mM, about 200 mM to about 1500 mM, about 400 mM to about 1500 mM, about 600 mM to about 1500 mM, about 800 mM to about 1500 mM, about 1000 mM to about 1500 mM, about 20 mM to about 1000 mM, about 50 mM to about 1000 mM, about 80 mM to about 1000 mM, about 100 mM to about 1000 mM, about 120 mM to about 1000 mM, about 200 mM to about 1000 mM, about 400 mM to about 1000 mM, about 600 mM to about 1000 mM, about 800 mM to about 1000 mM, about 20 mM to about 800 mM, about 50 mM to about 800 mM, about 80 mM to about 800 mM, about 100 mM to about 800 mM, about 120 mM to about 800 mM, about 200 mM to about 800 mM, about 400 mM to about 800 mM, about 600 mM to about 800 mM, about 20 mM to about 600 mM, about 50 mM to about 600 mM, about 80 mM to about 600 mM, about 100 mM to about 600 mM, about 120 mM to about 600 mM, about 200 mM to about 600 mM, about 400 mM to about 600 mM, about 20 mM to about 400 mM, about 50 mM to about 400 mM, about 80 mM to about 400 mM, about 100 mM to about 400 mM, about 120 mM to about 400 mM, about 200 mM to about 400 mM, about 20 mM to about 200 mM, about 50 mM to about 200 mM, about 80 mM to about 200 mM, about 100 mM to about 200 mM, about 120 mM to about 200 mM, about 20 mM to about 120 mM, about 50 mM to about 120 mM, about 80 mM to about 120 mM, about 100 mM to about 120 mM, about 20 mM to about 100 mM, about 50 mM to about 100 mM, about 80 mM to about 100 mM, about 20 mM to about 80 mM, about 50 mM to about 80 mM, about 20 mM to about 50 mM, about 20 mM, about 50 mM, about 80 mM, about 100 mM, about 120 mM, about 200 mM, about 400 mM, about 600 mM, about 800 mM, about 1000 mM, about 1500 mM, about 2000 mM, at least about 20 mM, at least about 50 mM, at least about 80 mM, at least about 100 mM, at least about 120 mM, at least about 200 mM, at least about 400 mM, at least about 600 mM, at least about 800 mM, at least about 1000 mM, at least about 1500 mM, at least about 2000 mM, or any value or range therebetween. In a preferred embodiment, the concentration of the metal salt is 80 mM or 120 mM. In a further preferred embodiment, the concentration of the metal salt is 80 mM.

The reversible electrochemical mirror of the present invention may further comprise an electrochemical mediator. Adding the electrochemical mediator may advantageously improve the ionic conductivity of the electrolyte and aid in the continuous electrodeposition/dissolution of the electrodeposited film.

In some embodiments, the electrochemical mediator may comprise potassium iodide, 1,10-phenanthroline, copper(II) chloride, tin(II) chloride, BiCl₃, NiCl₂, FeCl₂, FeCl₃, ZnCl₂, and Pb(ClO₄)₂, or combinations thereof. In a preferred embodiment, the electrochemical mediator is potassium iodide.

The electrochemical mediator may be present in the reversible electrochemical mirror electrochromic device of the present invention, in a range of about 0.5 mM to about 120 mM, about 1 mM to about 120 mM, about 1.2 mM to about 120 mM, about 3 mM to about 120 mM, about 6 mM to about 120 mM, about 10 mM to about 120 mM, about 20 mM to about 120 mM, about 50 mM to about 120 mM, about 80 mM to about 120 mM, about 100 mM to about 120 mM, about 0.5 mM to about 100 mM, about 1 mM to about 100 mM, about 1.2 mM to about 100 mM, about 3 mM to about 100 mM, about 6 mM to about 100 mM, about 10 mM to about 100 mM, about 20 mM to about 100 mM, about 50 mM to about 100 mM, about 80 mM to about 100 mM, about 0.5 mM to about 80 mM, about 1 mM to about 80 mM, about 1.2 mM to about 80 mM, about 3 mM to about 80 mM, about 6 mM to about 80 mM, about 10 mM to about 80 mM, about 20 mM to about 80 mM, about 50 mM to about 80 mM, about 0.5 mM to about 50 mM, about 1 mM to about 50 mM, about 1.2 mM to about 50 mM, about 3 mM to about 50 mM, about 6 mM to about 50 mM, about 10 mM to about 50 mM, about 20 mM to about 50 mM, about 0.5 mM to about 20 mM, about 1 mM to about 20 mM, about 1.2 mM to about 20 mM, about 3 mM to about 20 mM, about 6 mM to about 20 mM, about 10 mM to about 20 mM, about 0.5 mM to about 10 mM, about 1 mM to about 10 mM, about 1.2 mM to about 10 mM, about 3 mM to about 10 mM, about 6 mM to about 10 mM, about 0.5 mM to about 6 mM, about 1 mM to about 6 mM, about 1.2 mM to about 6 mM, about 3 mM to about 6 mM, about 0.5 mM to about 3 mM, about 1 mM to about 3 mM, about 1.2 mM to about 3 mM, about 0.5 mM to about 1.2 mM, about 1 mM to about 1.2 mM, about 0.5 mM to about 1 mM, about 0.5 mM, about 1 mM, about 1.2 mM, about 3 mM, about 6 mM, about 10 mM, about 20 mM, about 50 mM, about 80 mM, about 100 mM, about 120 mM, at least about 0.5 mM, at least about 1 mM, at least about 1.2 mM, at least about 3 mM, at least about 6 mM, at least about 10 mM, at least about 20 mM, at least about 50 mM, at least about 80 mM, at least about 100 mM, at least about 120 mM, or any values or ranges therebetween. In a preferred embodiment, the concentration of the electrochemical mediator present in the REM of the present invention is about 6 mM.

The reversible electrochemical mirror of the present invention may further comprise a polymer host. Adding the polymer host may turn the electrolyte into a quasi-solid state electrolyte and thus advantageously result in increased performance of the electrolyte.

In some embodiments, the polymer host may comprise gelatin, hydroxyethylcellulose, poly(methyl methacrylate), poly(vinylidene fluoride), poly (acrylonitrile), poly (propylene carbonate), polyethylene oxide, polyvinyl (alcohol), polyvinyl butyral, or any combinations thereof. In a preferred embodiment, the polymer host is gelatin.

The polymer may be present in the electrolytic solution in a range of about 0.5 wt % to about 30 wt %, about 0.75 wt % to about 30 wt %, about 1 wt % to about 30 wt %, about 1.5 wt % to about 30 wt %, about 2 wt % to about 30 wt %, about 5 wt % to about 30 wt %, about 10 wt % to about 30 wt %, about 15 wt % to about 30 wt %, about 20 wt % to about 30 wt %, about 25 wt % to about 30 wt %, about 0.5 wt % to about 25 wt %, about 0.75 wt % to about 25 wt %, about 1 wt % to about 25 wt %, about 1.5 wt % to about 25 wt %, about 2 wt % to about 25 wt %, about 5 wt % to about 25 wt %, about 10 wt % to about 25 wt %, about 15 wt % to about 25 wt %, about 20 wt % to about 25 wt %, about 0.5 wt % to about 20 wt %, about 0.75 wt % to about 20 wt %, about 1 wt % to about 20 wt %, about 1.5 wt % to about 20 wt %, about 2 wt % to about 20 wt %, about 5 wt % to about 20 wt %, about 10 wt % to about 20 wt %, about 15 wt % to about 20 wt %, about 0.5 wt % to about 15 wt %, about 0.75 wt % to about 15 wt %, about 1 wt % to about 15 wt %, about 1.5 wt % to about 15 wt %, about 2 wt % to about 15 wt %, about 5 wt % to about 15 wt %, about 10 wt % to about 15 wt %, about 0.5 wt % to about 10 wt %, about 0.75 wt % to about 10 wt %, about 1 wt % to about 10 wt %, about 1.5 wt % to about 10 wt %, about 2 wt % to about 10 wt %, about 5 wt % to about 10 wt %, about 0.5 wt % to about 5 wt %, about 0.75 wt % to about 5 wt %, about 1 wt % to about 5 wt %, about 1.5 wt % to about 5 wt %, about 2 wt % to about 5 wt %, about 0.5 wt % to about 2 wt %, about 0.75 wt % to about 2 wt %, about 1 wt % to about 2 wt %, about 1.5 wt % to about 2 wt %, about 0.5 wt % to about 1.5 wt %, about 0.75 wt % to about 1.5 wt %, about 1 wt % to about 1.5 wt %, about 0.5 wt % to about 1 wt %, about 0.75 wt % to about 1 wt %, about 0.5 wt % to about 0.75 wt %, about 0.5 wt %, about 0.75 wt %, about 1 wt %, about 1.5 wt %, about 2 wt %, about 5 wt %, about 10 wt %, about 15 wt %, about 20 wt %, about 25 wt %, about 30 wt %, at least about 0.5 wt %, at least about 0.75 wt %, at least about 1 wt %, at least about 1.5 wt %, at least about 2 wt %, at least about 5 wt %, at least about 10 wt %, at least about 15 wt %, at least about 20 wt %, at least about 25 wt %, at least about 30 wt %, or any range or value therebetween. In a preferred embodiment, the polymer host may be present in the electrolytic solution in a weight percentage of about 1 wt %.

In an embodiment, the reversible electrochemical mirror of the present invention comprises an electrolytic solution, wherein the electrolytic solution comprises choline chloride, glycerol, water, and a copper salt.

In another embodiment, there is provided a reversible electrochemical mirror, comprising a first electrode, a second electrode deposited with metal atoms, and an electrolytic solution disclosed herein, wherein the electrolytic solution is disposed between the first electrode and second electrode, wherein the application of negative potential on the first electrode relative to the second electrode causes the deposited metal atoms to be dissolved from the second electrode into the electrolytic solution and to be electrodeposited from the electrolytic solution onto the first electrode; and wherein the application of positive potential on the first electrode relative to the second electrode causes the deposited metal atoms to be dissolved from the first electrode into the electrolytic solution and to be electrodeposited from the electrolytic solution onto the second electrode.

In the present invention, each of the two electrodes may be transparent and conducting. They may also function either as the working electrode or the counter electrode. In an embodiment, the electrodes may be made of the same or different materials.

In some embodiments, the electrodes may be made from transparent conducting substrates, comprising fluorine doped tin oxide (FTO), indium tin oxide (ITO)), conductive polymers, metal grids, random metallic networks, nanowire meshes, ultra thin metal films, carbon nanotubes, graphene, reduced graphene oxide, or combinations thereof.

In some embodiments, the REM of the present invention may comprise a third electrode that functions as a reference electrode. The third electrode may be electrochemically inert in some embodiments. In other embodiments, the third electrode is a silver wire. In other embodiments, the reference electrode may also be transparent and/or conducting.

The REM may also contain an energy storage mechanism. The energy storage capability of the REM is enhanced when reduced graphene oxide is incorporated as an ion storage layer. In some embodiments, the REM may function as a battery. In other embodiments, the REM may function as an energy storage device. In further embodiments, the REM may function as a battery, energy storage device, as part of any device requiring power and which the power may be provided by the REM, as part of any device generating power and which the power may be taken up by the REM, or combinations thereof.

The enhancement in energy storage capability appears to be from the facilitation of a Cl⁻/ClO⁻ redox reaction at the cathode that balances with Cu deposition at the anode. The redox reaction facilitated by the rGO layer may not be limited to simply the Cl⁻/ClO⁻ redox pair, and may suitably include any ions, compounds, or chemicals that may be oxidized at the cathode. In some embodiments, the REM battery of the present invention may be used as a power source to drive light emitting diodes (LEDs), devices, sensors, or as a capacitator, or combinations thereof.

The present invention also provides a method for preparing the electrolytic solution described herein, comprising the steps of: (1) mixing deep eutectic solvent with an aqueous solvent to form a hybrid electrolyte; (2) mixing metal salt, electrochemical mediator and/or polymer host with the hybrid electrolyte to form an electrolytic solution; (4) injecting the electrolytic solution between two transparent electrodes.

In forming the electrolytic solution disclosed herein, an elevated temperature of 70° C. may be preferred to dissolve and homogenise the chemicals used. Significantly lower temperatures may result in undesired inhomogeneity during the preparation, whereas extremely high temperatures may result in the degradation of chemicals. An elevated temperature may be particularly preferred when forming the polymer host to form the semi-solid-state or quasi-solid-state electrolyte of the present invention. Hence, the preparation of the electrolytic solution may be performed in the range of about 60° C. to about 130° C., about 70° C. to about 130° C., about 80° C. to about 130° C., about 90° C. to about 130° C., about 100° C. to about 130° C., about 110° C. to about 130° C., about 120° C. to about 130° C., about 60° C. to about 120° C., about 70° C. to about 120° C., about 80° C. to about 120° C., about 90° C. to about 120° C., about 100° C. to about 120° C., about 110° C. to about 120° C., about 60° C. to about 110° C., about 70° C. to about 110° C., about 80° C. to about 110° C., about 90° C. to about 110° C., about 100° C. to about 110° C., about 60° C. to about 100° C., about 70° C. to about 100° C., about 80° C. to about 100° C., about 90° C. to about 100° C., about 60° C. to about 90° C., about 70° C. to about 90° C., about 80° C. to about 90° C., about 60° C. to about 80° C., about 70° C. to about 80° C., about 60° C. to about 70° C., about 60° C., about 70° C., about 80° C., about 90° C., about 100° C., about 110° C., about 120° C., about 130° C., at least about 60° C., at least about 70° C., at least about 80° C., at least about 90° C., at least about 100° C., at least about 110° C., at least about 120° C., at least about 130° C., or any range or value therebetween.

In a further embodiment, the present invention provides for a use of an electrolytic solution in a reversible electrochemical mirror, wherein the electrolytic solution comprises a deep eutectic solvent; at least about 20 wt % aqueous solvent based on the total weight of deep eutectic solvent and aqueous solvent; and metal salt.

### EXAMPLES

Non-limiting examples of the invention and comparative examples will be further described in greater detail by reference to specific examples, which should not be construed as in any way limiting the scope of the invention.

### Example 1: Preparation of Electrolytic Solution and Quasi-Solid-State Solution

### Example 1a: Preparation of Electrolytic Solution

Choline chloride was treated in a vacuum oven at 70° C. overnight to remove residual water. Deep eutectic solvent (DES) was prepared by mixing choline chloride and glycerol in the weight ratio of 1:3, followed by stirring at 70° C. The hybrid electrolyte was prepared by mixing DES and water in the volume ratio of 7:3, followed by stirring at 70° C. To prepare the electrolytic solution, copper(II) chloride (80 mM) was dissolved in the hybrid electrolyte, followed by stirring at 70° C. until the solution was homogenous.

### Example 1b: Preparation of Quasi-Solid-State Solution

Potassium iodide (KI) (6 mM) as the electrochemical mediator and gelatin (1 wt %) as the polymer host were added to the electrolytic solution of Example 1a, followed by stirring at 70° C. until a homogenous quasi-solid-state solution was obtained.

### Example 1c: Two-Electrode Electrochemical Testing

For the energy storage work, the galvanostatic charge-discharge analysis was conducted in a beaker with both FTO substrates as the working and counter electrodes for the Cu hybrid REM battery. For the Cu hybrid/rGO REM battery, the galvanostatic charge-discharge analysis was also conducted in a beaker with FTO substrate as the working electrode and rGO/FTO substrate as the counter electrode. The electrolytic solution of Example 1a was used as the electrolyte reservoir.

### Example 1d: Two-Electrode Electrochemical Cuvette Testing

This in-situ electrochemical testing was conducted in a cuvette (placed inside a sample holder in the UV-Vis-NIR spectrophotometer) with both FTO substrates as the working and counter electrodes for the Cu hybrid REM battery. For Cu hybrid/rGO REM battery, the in-situ electrochemical testing was also conducted in a cuvette with FTO substrate as the working electrode and rGO/FTO substrate as the counter electrode. The electrolytic solution of Example 1a was used as the electrolyte reservoir.

### Example 1e: Three-Electrode Electrochemical Testing

The electrochemical analyses of electrolytes were studied using a three-electrode electrochemical setup in a beaker. Ag/AgCl and Pt electrodes were used as the reference electrode and counter electrode, respectively, with bare FTO or rGO/FTO as the working electrode. The electrolytic solution of Example 1a was used as the electrolyte reservoir unless specified otherwise.

### Example 1f: Three-Electrode Electrochemical Cuvette Testing

The in-situ electrochemical testing was conducted in a cuvette (placed inside a sample holder in the UV-Vis-NIR spectrophotometer) with FTO substrate as the working electrode, Pt wire as the counter electrode, and Ag wire as the reference electrode. The electrolytic solution of Example 1a was used as the electrolyte reservoir for this cuvette testing unless specified otherwise.

### Example 2: Reversible Electrochemical Mirror (REM) Electrochromic Device

### Example 2a: Two-Electrode Device

The REM was assembled using FTOs as both the counter and working electrodes. The electrolytic solution of Example 1a was sandwiched between the two electrodes via injection.

For the REM demonstrations, two devices (trapezoidal size of 4.0 cm×5.0 cm×4.0 cm) were assembled and retrofitted into a 3D-printed eyewear. The devices were tested concurrently. The 3D-printed Rubik's cubes were used as the objects of interest in the demonstration.

### Example 2b: Three-Electrode Device

The REM was assembled using FTOs as both the counter and working electrodes. Silver (Ag) wire (reference electrode) was inserted between the counter and working electrodes (with spacers attached) in a serpentine manner. The electrolytic solution of Example 1a or the quasi-solid-state solution of Example 1b was sandwiched between the two electrodes via injection. For the electrochromic behavior analysis, the REM had an active area of 4.0×1.5 cm 2.

### Example 3: Ratio of Deep Eutectic Solvent (DES) Components

Cu film was electrodeposited onto FTO electrode (Cu/FTO electode) using the test in Example 1e using DES electrolyte (i.e. where the ratio of ChCl:glycerol was 1:3). A second test was prepared according to Example 1e, except the ratio of ChCl:glycerol was adjusted to 1:2.

As shown in FIG. 18, when the ratio of ChCl:glycerol was 1:2, the obtained Cu mirror film showed a reflectance of 35.3% at the wavelength of 660 nm. At a higher proportion of glycerol at ChCl:glycerol=1:3, a higher reflectance of 39.6% was observed, indicating a higher electrodeposition from the DES electrolyte.

### Example 4: Ratio of Deep Eutectic Solvent: Water

Cu film was electrodeposited onto FTO electrode (Cu/FTO electode) using the test in Example 1e using hybrid electrolyte (i.e. where the ratio of DES:water 7:3). A second and third test were prepared according to Example 1e, except the ratio of DES:water was adjusted to 17:3 and 47:3, respectively.

As shown in FIG. 19, at the same electrodeposition potential (−1.5 V for 500 seconds) and a wavelength of 660 nm, the Cu film electrodeposited from the electrolyte with a ratio of DES:water=7:3 exhibited the highest reflectance of 72.3%, followed by 59.6% (DES:water=17:3) and 46.4% (DES:water ratio of 47:3). At 780 nm, the electrodeposited Cu film exhibited the highest reflectance of 79.6% when the DES:water ratio was 7:3.

### Example 5: Ratio of Electrochromic Material

Cu film was electrodeposited onto FTO electrode (Cu/FTO electode) using the test in Example 1e using hybrid electrolyte (i.e. copper(II) chloride (80 mM)). A second test was prepared according to Example 1e, except 120 mM copper(II) chloride was used. The results are shown in FIG. 20 and Table 1:

TABLE 1

| Concentra- | | Wavelength | | | | |
|---|---|---|---|---|---|---|
| tion of | | 400 nm | 500 nm | 600 nm | 700 nm | 800 nm |
| copper(II) | | (Reflec- | (Reflec- | (Reflec- | (Reflec- | (Reflec- |
| chloride | | tance (%)) | tance (%)) | tance (%)) | tance (%)) | tance (%)) |
| 80 | mM | 31.5% | 34.7% | 38.1% | 38.5% | 36.5% |
| 120 | mM | 33.4% | 34.3% | 37.4% | 41.7% | 42.0% |

### Example 6: Polymer Host Concentration

An REM was prepared according to Example 2b using quasi-solid-state solution (i.e. 1 wt % polymer host). A second and third REM were prepared according to Example 2b, except 0.75 wt % and 1.5 wt % polymer host were used, respectively.

As shown in FIGS. 21a, 21b and 21c, when 1.0 wt % of gelatin as the polymer host was used, the reversible electrochemical mirror showed the highest transmittance modulation of 40% and longer cycling stability compared to other weight percentages of gelatin used.

### Example 7: Electrochemical Mediator Concentration

An REM was prepared according to Example 2b using quasi-solid-state solution (i.e. 6 mM electrochemical mediator). A second and third REM were prepared according to Example 2b, except 1.2 mM and 12 mM electrochemical mediator were used, respectively. As shown in FIGS. 22a, 22b and 22c, a concentration of 6 mM KI showed the best cycling of 550 cycles, followed by 200 cycles (1.2 mM KI) and 82 cycles (12 mM KI).

### Example 8: Measuring Ionic Conductivity of Hybrid Electrolyte

The conductivity of an electrolyte is a function of degree of dissociation, composition of the electrolyte, mobility of the individual ions, viscosity, and temperature. Higher ionic conductivity promotes faster rate of electrodeposition and dissolution as diffusion of ions takes place readily.

The ionic conductivities of Cu in the three different electrolyte systems were investigated via Electrochemical Impedance Spectroscopy (EIS) as shown in FIG. 1b. From the EIS comparison, Cu salt in water has the highest ionic conductivity of 2.73×10⁻⁴ S cm⁻¹, followed by Cu salt in the hybrid electrolyte (Example 1) (1.55×10⁻⁴ S cm⁻¹) while Cu salt in DES (ChCl:glycerol, 1:3) has the lowest ionic conductivity of 8.04×10⁻⁵ cm⁻². As shown in FIG. 1b, the hybrid electrolyte attains ionic conductivity close to Cu salt in water-based electrolyte due to the ease of ion diffusion.

FIG. 2 displays the Nyquist plot of the hybrid electrolyte (Example 1) with a semicircle in the high-frequency region, in which the semi-circle is attributed to the charge transfer impedance. The EIS pattern can be fitted by the equivalent circuit with resistive and capacitive combination, as shown in the inset of FIG. 2. The equivalent circuit elements were deduced by fitting the experimental data with the equivalent circuit by using the ZView software. R1 denotes the resistance ascribed to the electrodes and electrolyte, R2 denotes the charge-transfer resistance, and the constant phase element (CPE2) is correlated to the associated capacitance. The experimental data fits well with the values calculated from the equivalent circuit (R1=29.5Ω, R2=362.4Ω, CPE-T=2.36×10⁻⁵Ω⁻¹s, and CPE-P=0.87 Ω⁻¹s) as can be seen in FIG. 2.

FIG. 3 shows the Coulombic efficiency in triplicate, of the Cu film electrodeposition/dissolution on the FTO electrode in the hybrid electrolyte (Example 1). Results were calculated from the cyclic voltammogram studies conducted at the scan rate of 50 mV s⁻¹ with Pt and Ag/AgCl as counter and reference electrodes in the electrolytic solution in the potential range from −1.30 to +0.60 V. The hybrid electrolyte exhibited an efficiency of 74.56±1.78% after 500 cycles, reaching 88.39±1.68% after 5,000 cycles and 96.14±1.69% after 10,000 cycles. These results demonstrate that the hybrid electrolyte comprising DES and water has excellent reversibility in terms of electrodeposition and dissolution of the Cu hybrid system upon prolonged cycling.

### Example 9: Reversible Electrochemical Mirror Exhibiting at Least One Reflective State

FIG. 4 shows the illustration of randomly distributed Cu²⁺ ions within the hybrid electrolyte in the REM electrochromic device of Example 2b using hybrid electrolyte when no voltage is applied. For the three-electrode REM electrochromic device, the colored state is obtained at −0.5 V (FIG. 4(b)). At −1.0 V (FIG. 4(c)), most of the Cu²⁺ ions are reduced to Cu ° to form reflective Cu mirror film and hence, less Cu²⁺ ions are available in the electrolyte reservoir. FIG. 4(d) illustrates the electrochemical deposition of Cu²⁺ ions to form the Cu mirror film in the REM electrochromic device. With reverse bias, the mirror film dissolves back into the electrolyte reservoir, hence increasing the transmittance of the device back to the clear state. The electrochemical reactions for the electrochemical deposition of Cu ions in the hybrid electrolyte are as follows:

Formation of Red Colored Film (−0.5 V Vs. Ag/AgCl):

CuCl₂+e⁻→CuCl+Cl⁻

Formation of Mirror Film (−1.0 V Vs. Ag/AgCl):

CuCl+e⁻→Cu+Cl⁻

### Example 10: Structural and Morphological Characterizations

The characterization of the crystal structure of both the red colored film and mirror film were performed by employing X-Ray diffraction (XRD) using a Shimadzu discover diffractometer with Cu Kα-radiation (λ=1.5406 Å). As can be seen from FIG. 5a, the XRD diffraction peaks of the mirror film (electrodeposited at −1.2 V for 120 seconds) can be reasonably indexed to Cu (cubic, #00-004-0836) and CuO (monoclinic, #00-003-0867) where the rest of the peaks can be ascribed to the FTO substrate (SnO₂). The XRD diffraction peaks of the red colored film can be attributed to the red Cu₂O (cubic, #00-035-1091) and Cu (cubic, #00-004-0836).

The morphology of Cu mirror film were analyzed using Scanning Electron Microscopy (SEM, Carl Zeiss, Model Supra 55). FIG. 5b is a representative image of the Cu mirror film. The size of the Cu nanoparticles ranged from 71 to 386 nm, which were slightly larger compared to the Cu nanoparticles (30-50 nm) electrodeposited from the DMSO electrolyte reported in previous works. The presence of polyvinyl alcohol (PVA) in the DMSO electrolyte promotes slower and more controlled electrodeposition of Cu nanoparticles, which prevents the growth or agglomeration of Cu nanoparticles.

The comparatively larger Cu nanoparticles electrodeposited from the hybrid electrolyte was attributed to the faster rate of electrodeposition of Cu nanoparticles that correlated well with the higher ionic conductivity. Excessive particle growth leading to agglomeration is not desirable as it will prevent the formation of a homogeneous and compact film critical for higher reflectivity due to the minimal diffusive reflectance.

### Example 11: Electrochromic Performance

Commercial electrochromic devices have been used as smart glasses to govern the incoming solar irradiation into the buildings thus reduce energy consumption. REM electrochromic devices possessing electrochemical tunability in various optical states (transparent, mirror, and colored states) are viewed as exciting alternatives to the traditional smart glasses. These tunable mirrors serve as promising candidates for electronic displays, thermal control, privacy glass, visor control, and camouflage.

In order to comprehend the electrochromic behavior of Cu hybrid electrolyte in the REM electrochromic device (Example 2b), in-situ transmittance and reflectance analyses were performed under various voltages. As can be seen from FIG. 6a, the in-situ transmittance spectra of the REM device were analyzed at the applied voltages (vs. Ag/AgCl) of −0.5 V, −0.8 V, −1.0 V, −1.2 V and +0.2 V for 60 seconds (wavelength range: 400-800 nm). The REM electrochromic device exhibited a high transmittance of 79.34% at 550 nm at its neutral transparent state, with air as the baseline. At −0.8 V, the device showed a tinted state with transmittance contrast of 55.81%. The device showed a maximum transmittance contrast of 75.21% under the alternating voltages of −1.2 and +0.2 V.

From the reflectance spectra, the Cu film showed a reflectance contrast of 8.58% at 780 nm at −1.0 V (FIG. 6b). At −1.0 V, Cu²⁺ was reduced to Cu ° to form the Cu mirror film, resulting in a change in the reflectivity of the REM electrochromic device. This corresponds well to the second cathodic peak (II_{c}=−1.0 V) in the cyclic voltammogram in FIG. 1a. In fact, the device reflectivity increases with increased voltage and extended electrodeposition time. The REM device showed a maximum reflectance of 72.79% with a reflectance contrast of 55.93% at 780 nm when switched between −1.5 and +0.2 V for 5 minutes respectively.

### Example 12: Durability Testing

For practical applications, the durability of the electrochromic system has become one of the key determining factors prior to adoption of the technology. For repeatability purpose, the cycling stability test was conducted in triplicate using the voltage algorithm VA1 as shown in FIG. 7. Another voltage algorithm VA2 is also shown in FIG. 7.

In the three electrode electrochemical cuvette testing according to Example 1f, the hybrid electrolyte demonstrated a robust cycling stability over 5,000 cycles with minor degradation of 4.71% (FIG. 6c). This robust switching between the low transmittance (on state) and high transmittance (off state) confirms the excellent reversibility in the electrodeposition/dissolution of Cu in the hybrid electrolyte. The electrodeposited Cu/FTO electrode showed an initial transmittance contrast of 49.67% and attained a maximum transmittance contrast of 49.99% at 2,500th cycle. The transmittance contrast of the Cu/FTO electrode gradually decreases after reaches a transmittance contrast of 44.96% after 5,000 cycles with minor degradation (9.48%). In contrast, conventional Cu/ITO REM electrochemical devices using DMSO as an electrolyte reached a transmittance contrast of 42.67% after 900 cycles but showed significant degradation (38.64%).

To probe the underlying factors causing electrochromic performance degradation, the electrodeposited Cu/FTO electrode was analyzed using Scanning Electron Microscopy (SEM) with the SEM images shown in FIG. 8a. The film morphology reveals slight agglomeration of the Cu nanoparticles, as well as less densely deposited Cu nanoparticles, both of which caused irregularity in film thickness. Additionally, it becomes increasingly difficult to achieve complete film dissolution owing to the non-uniform electrical field distribution on the irregular thickness of Cu mirror film. The structural integrity of the Cu mirror film after cycling was also investigated using X-Ray Diffraction (XRD). From the XRD analysis as shown in FIG. 8b, the film revealed no structural change and the film composition was largely unchanged after 5000 cycles, in which Cu remained the major component.

### Example 13: Switching Speed Performance

In electrochromic device application, the switching speed describes the kinetics of the electrochemical process when transiting from one state to another state when an alternating voltage is applied. Switching speed is one of the most important features presented in the technical specifications of electrochromic devices and determines the competitive features of electronic displays and smart glass.

The switching speed is described as the time required for an electrochromic system to attain 90% of its full optical contrast between the bleached state and the steady colored state. The evaluation of the kinetics of the electrochemically deposited Cu in the hybrid electrolyte environment over long cycling processes is described below, where nucleation and film growth analysis would provide fundamental understanding of electrodeposition process.

The switching speed of the Cu film using the hybrid electrolyte in the REM (three-electrodes electrochemical cuvette testing of Example 1f) was studied via in-situ transmittance response at 550 nm using voltage algorithm VA1. The cycle kinetics of the Cu hybrid electrolyte at different switching cycles was investigated and the results are shown in FIG. 6d. The low transmittance corresponds to the formation of Cu film whereas the high transmittance corresponds to Cu film dissolution. The coloration speed was relatively fast and steady (1st cycle: 7.4±0.3 seconds; 5000th cycle: 7.0±0.3 seconds), and is much faster compared to conventional REMs having coloration speeds of up to 29.4 seconds. The bleaching speed in contrast, gradually increased to 19.7±3.6 seconds at 5000th cycle from 13.7±2.1 seconds at the first cycle, indicating increasing challenging film dissolution under prolonged cycling. The significantly faster coloration speed can be correlated with undissolved Cu nanoparticles that function as a nucleation layer and assist subsequent electrodeposition of the Cu films (FIG. 9).

To analyze the switching speed for mirror film formation and dissolution in the hybrid electrolyte, the in-situ reflectance response was studied at the wavelength of 780 nm using the voltage algorithm VA2. The switching speed was determined to be 225.2 s and 56.5 s for mirror film formation and dissolution respectively when reflectance contrast of 51.8% was achieved (FIG. 10). Generally, longer electrodeposition and dissolution times are required to attain higher film reflectivity and complete film dissolution. From FIG. 11a, the Cu mirror film showed a memory retention of 27.12 min upon application of −1.5 V for 10 min at the wavelength of 780 nm. The red colored film showed a memory retention of 66.63 min at the wavelength of 550 nm as shown in FIG. 11b. The excellent memory effect could be attributed to the presence of DES in the Cu hybrid electrolyte, which renders a more viscous electrolyte.

For practical, well-sealed electrochromic devices, liquid electrolytes are often not preferred due to concerns over electrolyte leakage, presence of bubbles, hydrostatic pressure concerns and poor chemical stability. Conversely, solid electrolytes show subpar electrochromic performance, poor interfacial properties, and inferior ionic conductivity due to poor ion mobility. This present invention thus provided for a quasi-solid-state (with gelatin added) combining the advantages of both the solid-state electrolytes (cohesive properties) and liquid electrolytes (diffusive transport properties), for example excellent interfacial properties, good wettability, easy application, high ionic conductivity, and excellent cycling stability. The electrochromic properties of the quasi-solid-state electrolyte was examined using voltage algorithm VA3 as shown in FIG. 12, with the results shown in FIG. 13a and FIG. 13b.

As can be seen from FIG. 13a, the quasi-solid-state REM electrochromic device showed an initial transmittance modulation of 46.74%, reaching a maximum transmittance contrast of 58.13% at the 10th cycle. At the maximum transmittance contrast, the device showed a good coloration time of 9.7 s and bleaching time of 77.3 s, as shown in FIG. 13b. In fact, the REM electrochromic device demonstrated better electrochromic contrast over time, with the transmittance contrast increasing by 5.51% after 30 cycles.

In REMs, most efforts have been fixated on realizing high performance (fast response, large contrast, long stability), yet the kinetics of film formation has not been perfectly understood. This work evaluates the Cu electrodeposition kinetics in a hybrid electrolyte over long cycling, where nucleation and film growth analysis would elucidate a fundamental understanding of the electrodeposition.

Throughout the cycling process, 0 V for 2 s and −1.0 V for 10 s (fixed time) was applied for the film formation for every cycle. The current-time (i-t) curves (absolute current values) were extracted for every 500 cycles for the total of 5,000 cycling process as shown in FIG. 14a and FIG. 14b. It can be observed that there is a sudden surge of the current (stage 1, first three seconds) for all the cycles. This is followed by a current saturation stage (stage 2, subsequent seconds up to 12 sec) for all 5000 cycles. To analyze the Avrami coefficient value and crystal nucleation frequency during the cycling process, a Johnson-Mehl-Avrami-Kolmogorov (JMAK) analysis,

X=1−e^{-ktn}

was applied for stage 1, where X=reaction ratio, t=reaction time, k=crystal nucleation frequency and n=crystal growth geometry factor. Current values were normalized over the saturation current and the double logarithmic plots of −ln (1−X) vs time for every 500 cycles are presented in FIG. 14c and FIG. 14d. The parameters, k and n were estimated from the intercept and slope and were plotted against the cycle number in FIG. 14e, following the analysis of ln[−ln(1−X)]=ln k+n ln t.

The parameter n reveals the growth dimension of crystal grains. The n values of different cycles are all slightly higher than 2, indicating that the initial film formation is due to the 2-dimensional (2D) growth of nuclei. As can be seen in FIG. 14e, the initial increase in k value (1st cycle to 1000th cycle) is ascribed to the increased number of new nucleation sites facilitating film growth, leading to a lower transmittance of the electrodeposited film as shown in FIG. 6c. From 1000th cycle to 2500th cycle, a dip in k value is likely related to non-dissolved nanoparticles, reducing the number of nucleation sites. These non-dissolved nanoparticles facilitate the electrodeposition of Cu nanoparticles, which further lower the transmittance of the electrodeposited Cu film. From 2500th cycle to 5000th cycle, the gradual increase in k value relates to accumulated number of nucleation sites, which caused patchiness in the electrodeposited film. This resulted in gradual increase in the film transmittance (FIG. 6c). It can be concluded that both the nucleation sites and non-dissolved nanoparticles assist the electrodeposition process as evident from the faster coloration time over prolonged cycling (FIG. 6d). However, the accumulation of nuclei and non-dissolved nanoparticles eventually caused patchiness and irregular film growth during electrodeposition of Cu film, leading to degradation in the electrochromic performance of the Cu hybrid electrolyte.

### Example 14: Reversible Electrochemical Mirror (REM) in 3D-Printed Eyewear

For the purpose of demonstrating the applicability of the REM of the present invention (Example 2a using hybrid electrolyte), two trapezoidal devices were retrofitted into a 3D-printed eyewear. The two devices were powered concurrently. FIG. 15(a) shows the setting of the REM electrochromic eyewear prototype with the 3D-printed Rubik's cubes placed at the back to demonstrate the transparent state, while FIG. 15(b) shows the red tinted state corresponding to the formation of the red film. To demonstrate the mirror state, the Rubik's cubes were positioned in front of the prototype. At the mirror state, the Rubik's cubes were reflected well on the eyewear prototype, and light transmission is no longer observed (FIG. 15(c)). This experiment shows that the REM electrochromic device of the present invention are highly attractive for visor control, electronic displays, and smart windows applications.

### Example 15: Reversible Electrochemical Mirror Battery

The Cu hybrid REM battery was prepared by sandwiching the electrolytic solution between two FTO electrodes (working and counter electrodes). The Cu hybrid/rGO REM battery was assembled by sandwiching the electrolytic solution between FTO working electrode and rGO/FTO counter electrode.

To fabricate the Cu hybrid/rGO REM battery, reduced graphene oxide (rGO) was selected as the cathode material due to the presence of functional groups, large surface area, high capacity, and semitransparency.

The amount of rGO was determined based on capacity and film transparency to offer high capacitance with high transparency of 68.41% (optimized rGO: electrophoretic deposition of GO at +0.5 V for 50 s and annealed at 200° C. in Ar gas) as shown in FIG. 26f. The Scanning Electron Microscopy (SEM) images of the FTO electrode before and after Electrophoretic Deposition

(EPD) of the reduced graphene oxide material are shown in FIG. 26d and FIG. 26e respectively.

From XRD diffraction analysis (FIG. 26b), the rGO exhibits broad peak of (002) located at 20 of 23.7°. In order to maintain the high transparency of rGO/FTO electrode, the thickness of rGO on FTO needs to beoptimized/tailored to remain highly transparent. However, due to the very thin rGO film (optimized rGO: electrophoretic deposition of GO at +0.5 V for 50 s and annealed at 200° C. in Ar gas), the characteristic peak of rGO (002) was not effectively detected. Under higher EPD potential and extended EPD duration (EPD of rGO on the FTO electrode at +3.0 V for 300 seconds), this broad peak was detected on a thicker rGO film on the FTO electrode, evidencing the formation of rGO following the EPD and annealing process.

The characteristic D band and G band of graphitic carbon were detected on rGO/FTO electrode, further confirming the presence of rGO on FTO after EPD and thermal annealing. The Raman spectrum results are shown in FIG. 26c. The intensity ratio of D band to G band (I_{D}/I_{G}) of rGO is higher than that of graphene oxide (GO), which indicates an increased size of sp 2 carbon domains and an increased amount of defects. Additionally, the G band of rGO is blue-shifted to 1591.5 cm⁻¹ compared to 1600.2 cm⁻¹ in graphene oxide (GO) which is comparable to reported literature. This is caused by “self-healing” effects that recover the hexagonal carbon networks.

### Example 16: Electrochemical Properties of the Cu Hybrid/rGO REM Battery

With the incorporation of rGO as the ion storage layer, the cyclic voltammetry (CV) scan as shown in FIG. 26a shows lower polarization as well as higher charge storage compared to the bare FTO electrode.

The Cu hybrid/rGO REM battery assembled with the optimized rGO electrode provided a longer discharging time and a higher capacity, as shown in FIG. 27a. Compared with the bare FTO electrode, the rGO electrode offers lower polarization and higher charge storage as indicated from a larger integrated area from the cyclic voltammogram in FIG. 27c, and with a smaller charge-transfer resistance as shown in the Nyquist plot in FIG. 27d.

### Example 17: Charge Storage Mechanism of the REM Battery

To investigate the charge storage mechanism of the Cu hybrid REM device on the rGO/FTO cathode, rGO/FTO samples at both the charged and discharged states were analyzed via X-ray photoelectron spectroscopy (XPS), with results being shown in FIGS. 24a and 24b. Because of spin-orbital splitting, the Cl 2p spectrum exhibits two peaks (2p_{3/2} and 2p_{1/2} with peak separation of 1.6 eV) after deconvolution.

For the charged rGO electrode (FIG. 24a), the major peak (198.4 eV) is characteristic of Cl 2p_{3/2} of the CuCl electrolyte residue. The minor peak (200.5 eV) is tentatively assigned to Cl 2p_{3/2} of ClO⁻. This verifies the presence of ClO⁻ species, which were oxidized from the Cl⁻ species in the electrolyte and adsorbed onto the rGO film during charging. The adsorption of ClO⁻ species onto the rGO film allows more charge to be stored. Conversely, this peak was not detected in the discharged sample (FIG. 24b). Only the peak at 198.4 eV ascribed to CuCl could be detected. This verifies the reversible redox between Cl⁻ (Cl valence state=−1) and ClO⁻ (Cl valence state=+1) species at the cathode. The redox behavior taking place at the cathode balances the electrochemical deposition/dissolution at the anode, endowing the intrinsic energy storage property of the full cell with the Cu hybrid electrolyte.

With rGO as the cathode, the Cu hybrid/rGO REM battery demonstrated excellent cycling stability (FIG. 24c). The device capacity increased to 101.4% after 2000 cycles and further increased to 115.5% after 5000 cycles. Even without rGO, the Cu hybrid REM battery still yielded 109.5% capacity retention after 5000 cycles, which proved the robustness of the Cu hybrid electrolyte.

The Cu hybrid/rGO REM battery manifests stable energy storage performance. Two discharge plateaus are still distinctive after 5000 cycles without a decay in the amount of charge stored (FIG. 24d). As an ion storage layer, rGO improves the charge balance between the anode and cathode and thus improves the discharge capacity (0.068 mAh cm⁻² at 0.3 mA cm⁻²; FIGS. 27a and 27b). This charge/discharge cycling stability of 5000 cycles is quite promising compared with that of conventional “rock-chair” rechargeable Li-ion batteries with a typical cycling stability of <2500 cycles.

Additionally, the Cu hybrid/rGO REM battery demonstrates high transmittance modulation of 65.60% (FIG. 27g) with a 81.92% retention of the initial transmittance modulation after cycling (FIG. 28b) as compared with the Cu hybrid REM battery (FIG. 28a).

In a full cell configuration, the Cu hybrid/rGO REM battery (FIG. 27g) achieves lower transmittance of 4.20% compared to 9.67% for the Cu hybrid REM battery (FIG. 27f) under the same applied potential. The Cu hybrid/rGO REM battery shows an initial transmittance of 67.32% at 550 nm (FIG. 28b) and exhibits good transmittance modulation of 65.60% when switched between −3.5 and +0.5 V (FIG. 27g).

This Cu hybrid/rGO REM battery also demonstrates good electrochromic cycling performance of 300 cycles with retention of 81.92% (FIG. 28b) of the initial transmittance contrast, compared to the Cu hybrid REM battery (FIG. 28a).

### Example 18: Real-Life Application of REM as a Battery

To demonstrate the energy storage mechanism of the REM in real life applications, three small devices, as made according to Example 2a using hybrid electrolyte and were successfully used to power a red LED indicator, a timer and a temperature and humidity sensor as shown in FIG. 25.

The REM devices, being able to power up different devices, amply show that the REMs of the present invention may be used as a battery in different situations.

### COMPARATIVE EXAMPLES

### Comparative Example 1: Cu-Based REM Device Using a Non-Aqueous DMSO Electrolyte

An REM was prepared according to Example 2b (i.e. using the hybrid electrolyte). A second REM was prepared according to Example 2b, except that non-aqueous DMSO was used instead of the hybrid electrolyte.

FIG. 23a shows the transmittance data of a Cu-based REM device using the non-aqueous DMSO electrolyte. The REM device of the present invention is able to maintain a significantly lower transmittance, less than 20%, at a lower operating voltage of −0.8 V (FIG. 6a) as compared to the comparative example, where a −0.9 V comparative voltage was required to maintain the same transmittance modulation. This shows the superior performance of the REM device using a hybrid electrolyte electrolytic solution as compared to the REM devices using a non-aqueous electrolyte.

Similarly, the REM device was able to reach similar levels of reflectance at a significantly lower voltage of −1.5 V (FIG. 6b) as compared to the comparative example, where a voltage of −1.8 V was needed to achieve the same level of reflectance (FIG. 23b).

As seen in FIG. 6c, the Cu hybrid electrolyte of the present invention was able to maintain the cycling performance even up to 5000 cycles. Conversely, the non-aqueous DMSO electrolyte faced significant cycling degradation after 900 cycles (FIG. 23c), implying that the dissolution was significantly reduced upon prolonged cycling.

As shown in FIG. 23d, the REM device utilizing non-aqueous DMSO electrolyte has a reflectance modulation of 58.90% at the wavelength of 660 nm. The time required for mirror formation and dissolution was 23.3 and 13.7 s, respectively.

### Comparative Example 2: Comparing REM Performance with and without the Presence of Water

To ascertain the unexpected performance of the hybrid electrolyte, two different deep eutectic solvents were prepared, using choline chloride (ChCl) and either glycerol or ethylene glycol. Results of the electrolytic solutions comprising these two different deep eutectic solvents are shown in FIG. 16 (ChCl+glycerol) and FIG. 17 (ChCl+ethylene glycol (EG)) respectively. For both studies, the ratio of the choline chloride to the hydrogen bond donor was kept at 1:3, and the weight ratio of the DES to water was maintained at 7:3.

As shown in FIG. 16, the Cu film achieves enhanced reflectivity of 79.6% at 780 nm compared to 36.8% in the absence of water. This is attributed to the higher ionic conductivity (1.55×10⁻⁴ S cm⁻¹) of the hybrid electrolyte as compared to that of the pure DES electrolyte (8.04×10⁻⁵ S cm⁻¹).

In the other study involving ChCl and EG, similar results were observed as well. The Cu film deposited from the pure DES electrolyte only showed a low reflectivity of 32.2% at 660 nm. Conversely, in the presence of water, the electrodeposited Cu film showed a significantly higher reflectance of 69.6% at the same wavelength.

At 780 nm, the Cu film electrodeposited from the ChCl+EG electrolyte showed a slightly higher reflectance of 80.8%, as compared to the Cu film electrodeposited from the ChCl+glycerol electrolyte (reflectance of 79.6%). This slightly higher reflectivity is anticipated as EG-based electrolytes are known to exhibit better ionic conductivity than glycerol based electrolytes. The enhanced ionic conductivity results in a faster electrodeposition rate of Cu nanoparticles, thus resulting in a denser and thicker film.

While it has been sufficiently shown that the REM of the present invention may work with different electrolytes, the rest of the studies were performed using glycerol as the hydrogen based donor as the objective of the study was to formulate a non-flammable and non-toxic electrolyte.

### Comparative Example 3: Electrochemical Analysis of the Redox Behavior of Cu in Different Electrolytes

The electrochemical analyses were studied using a three-electrode electrochemical configuration with Autolab PGSTAT30 potentiostat. Ag/AgCl and Pt electrodes were employed as the reference electrode and counter electrode. The electrochemical impedance spectroscopy (EIS) analysis was carried out at open circuit voltage by applying AC voltage (frequency range: 0.1-100 kHz; amplitude: 10 mV. The in-situ electrochemical analyses were conducted by employing UV-vis-NIR spectrometry (Perkin Elmer, Lambda 950) and Autolab potentiostat to acquire both the reflectance and transmittance spectra, switching test, and durability test. In the transmittance mode, the voltage algorithm, VA1 (−1.0 V (10 s), 0 V (30 s), +0.5 V (20 s), and 0 V (10 s) vs. Ag/AgCl was applied for the cycling stability test at the wavelength of 550 nm. In the reflectance mode, the VA2 (−1.5 V (300 s), 0 V (30 s), +0.5 (120 s), and 0 V (30 s) was applied to investigate the switching speed for mirror film formation and dissolution in the Cu hybrid electrolyte at 780 nm.

In order to understand the redox behaviors of Cu, cyclic voltammetry (CV) analyses of Cu electrodeposition/dissolution on the FTO electrode were performed at a scan rate of 5 mV s⁻¹ in three different electrolyte systems, namely, water-, DES-, and hybrid-based. As shown in FIG. 1, the DES-based electrolyte offers wide electrochemical potential window but shows poor current efficiency during both electrodeposition and dissolution processes. In contrast, water has a narrow electrochemical potential window but offers better current efficiency. Via hybridization strategy, the hybrid electrolyte inherits merits of a wide electrochemical potential window and shows an enhancement in the current efficiency. Notably, the most prominent feature of this hybrid electrolyte is the ability to tailor the redox peak positioning, which promotes the electrochemical activity of Cu. The cathodic peaks of Cu in hybrid electrolyte were detected earlier compared to those in the pure DES during the cathodic sweep, indicating the ease of electrochemical reduction of Cu. The first cathodic peak, I_{c} in the hybrid electrolyte was detected earlier at −0.46 V (L in DES≈−0.63 V) that corresponds to the electrochemical reduction of Cu²⁺ to Cu⁺. Similarly, the second cathodic peak, IL in the hybrid electrolyte was detected earlier at −1.00 V that corresponds to the electrochemical reduction of Cu⁺ to Cu⁰. Compared to the hybrid electrolyte, the second cathodic peak in the DES electrolyte exhibited a more negative electrochemical reduction potential of −1.42 V, indicating that the Cu⁺ ions in the hybrid electrolyte can undergo electrochemical reduction to Cu ° with ease. On the other hand, the second anodic peak, Iₐ in the hybrid electrolyte has shifted slightly to a lower oxidation potential of +0.12 V compared to +0.18 V in the DES electrolyte, demonstrating the improvement in the ease of film dissolution.

### Comparative Example 4: Zn-Based REM Battery

To compare the charge storage performance of the REM, a Zn-REM battery was prepared to serve as a comparison.

Gelatin (0.1 g) was dissolved in 1 mL of 1 M ZnSO₄ (aq) at 70° C. and used as an anolyte. When V²⁺ (equivalent against Zn foil) was added into the solution, the catholyte was obtained. The anolyte and the catholyte were transformed into gels at room temperature. To fabricate Zn-EMs, Zn-attached ITO-glass (7 Ωsq⁻¹), anolyte, anion-exchange membrane, catholyte, and ITO-glass were sandwiched together in this sequence. The thickness of the anolyte and the catholyte was adjusted to be approximately 400 jun by insulating double-sided adhesive. The Zn-REM prepared using ITO-glass was coined glass-Zn-REM.

A second comparative Zn-REM was prepared, except that ITO-PET was used instead of ITO-glass, and was coined PET-Zn-REM.

The glass-Zn-REM exhibited a highest reflectance of 21.2% (specific wavelength was not mentioned, can be estimated from the figure: 675-700 nm) after 105 s of initial discharging, as shown in FIG. 29a. The glass-Zn-REM exhibited a transmittance of 50.2% (also not mentioned, at about 800 nm) in its initial state, as shown in FIG. 29b. During subsequent charging experiments, the glass-Zn-REM exhibited a highest transmittance of 18.0% (at about 800 nm) after 240 s, as shown in FIG. 29c. When half of the cathodic ITO-glass was covered with insulating tape to avoid Zn electrodeposition and to allow UV-light to pass through, the transmittance of the glass-Zn-REM was increased to 50.0% (at about 800 nm) after 240 s of charging as shown in FIG. 29d.

In comparison, the REM of the present invention exhibited a highest reflectance of 72.79% at 780 nm as shown in FIG. 6b, and a highest transmittance of 79.34% at 550 nm as shown in FIG. 6a. This shows that the REM of the present invention exhibits enhanced reflectance as well as highly transparent state, illustrating the superior performance of the electrolytic solution of the present invention.

FIG. 29e further shows the cycling performance of the PET-Zn-REM of up to 10 cycles. As compared with the Zn-REM battery, the REM of the present invention was capable of up to 5000 charge/discharge cycles as shown in FIG. 24c, while also being capable of demonstrating 3 states, emphasizing the energy storage dual functionalities as exhibited by the REM of the present invention.

### INDUSTRIAL APPLICABILITY

The present invention relates to a reversible electrochemical mirror. Conventional reversible electrochemical mirrors comprise either purely aqueous or non-aqueous solvents, which limit their electrochemical performance. Further, there are added issues relating to flammability and toxicity of the non-aqueous solvents used. It is thus a surprising discovery of this invention that a reversible electrochemical mirror may be formed using a combination of both deep eutectic solvents as well as water. It is also a surprising discovery that the hybrid electrolytic solution possesses good cycling performance, far superior to that of the conventional reversible electrochemical mirrors. Thus, this invention is capable of industrial applicability.

The present invention also uses non-toxic and non-flammable materials in the electrolytic solution, thus reducing toxicity and flammability concerns. This can also be further employed to any other applications that also require similar safety considerations.

The present invention also relates to a use of an electrolytic solution in a reversible electrochemical minor. This use also employs a solution that is similarly non-toxic and non-flammable, and is thus similarly capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A reversible electrochemical mirror comprising an electrolytic solution, wherein the electrolytic solution comprises:
deep eutectic solvent;
at least about 20 wt % aqueous solvent based on the total weight of deep eutectic solvent and aqueous solvent; and
metal salt.

2. The reversible electrochemical mirror of claim 1, wherein the aqueous solvent is water.

3. The reversible electrochemical mirror of claim 1, wherein the weight ratio of deep eutectic solvent to aqueous solvent is in the range of about 4:1 to about 3:47.

4. The reversible electrochemical mirror of claim 1, wherein the deep eutectic solvent comprises an ionic species and hydrogen bond donor.

5. The reversible electrochemical mirror of claim 4, wherein the weight ratio of the ionic species to the hydrogen bond donor is about 1:1 to about 1:5.

6. The reversible electrochemical mirror of claim 4, wherein the ionic species is selected from the group consisting of quaternary ammonium salt, choline salt, choline chloride, choline bromide, choline acetate, chlorocholine chloride, lithium chloride, lithium acetate, lithium perchlorate, lithium triflate, lithium bistriflimide, lithium trifluoromethanesulfonate, lithium bis(trifluoromethanesulfonyl)imide, sodium chloride, sodium acetate, sodium perchlorate, sodium triflate, sodium bistriflimide, sodium trifluoromethanesulfonate, sodium bis(trifluoromethanesulfonyl)imide, potassium chloride, potassium acetate, potassium perchlorate, potassium triflate, potassium bistriflimide, potassium trifluoromethanesulfonate, potassium bis(trifluoromethanesulfonyl)imide, tetrabutylammonium trifluoromethanesulfonate, tetrabutylammonium chloride, tetrabutylammonium bromide, tetramethylammonium chloride, tetramethylammonium bromide, N-ethyl-2-hydroxy-N,N-dimethylethanaminium chloride, 2-(chlorocarbonyloxy)-N,N,N-trimethylethanaminium chloride, N-benzyl-2-hydroxy-N,N-dimethylethanaminium chloride, and combinations thereof.

7. The reversible electrochemical mirror of claim 4, wherein the hydrogen bond donor is selected from the group consisting of ethylene glycol, polyethylene glycol, urea, 1-methyl urea, 1,1-dimethyl urea, 1,3-dimethyl urea, thiourea, acetamide, benzamide, citric acid, malonic acid, benzoic acid, adipic acid, oxalic acid, succinic acid, and glycerol.

8. The reversible electrochemical mirror of claim 1, wherein the metal of the metal salt is selected from the group consisting of gold, silver, bismuth, lead, tin, nickel, iron, zinc, chromium, manganese, cobalt, palladium, cadmium, antimony, platinum, aluminum, magnesium, copper, and alloys thereof.

9. The reversible electrochemical mirror of claim 1, wherein the salt of the metal salt is selected from the group consisting of chloride, sulfate, nitrate, perchlorate, iodide, acetate, and phosphate.

10. The reversible electrochemical mirror of claim 1, wherein the electrolytic solution does not contain lithium, sodium and potassium salts.

11. The reversible electrochemical mirror of claim 1, wherein the concentration of metal salt in the electrolytic solution is in the range of about 20 mM to about 2 M.

12. The reversible electrochemical mirror of claim 1, wherein the electrolytic solution further comprises an electrochemical mediator.

13. The reversible electrochemical mirror of claim 12, wherein the electrochemical mediator is selected from the group consisting of potassium iodide, 1,10-phenanthroline, copper(II) chloride, tin(II) chloride, BiCl₃, NiCl₂, FeCl₂, FeCl₃, ZnCl₂, and Pb(ClO₄)₂.

14. The reversible electrochemical mirror of claim 1, wherein the concentration of electrochemical mediator in the electrolytic solution is in the range of about 1 mM to about 100 mM.

15. The reversible electrochemical mirror of claim 1, wherein the electrolytic solution further comprises a polymer host.

16. The reversible electrochemical mirror of claim 1, wherein the electrolytic solution further comprises about 1 wt % to about 20 wt % polymer host.

17. The reversible electrochemical mirror of claim 16, wherein the polymer host is selected from the group consisting of gelatin, hydroxyethylcellulose, poly(methyl methacrylate), poly(vinylidene fluoride), poly (acrylonitrile), poly (propylene carbonate), polyethylene oxide, polyvinyl (alcohol), and polyvinyl butyral.

18. The reversible electrochemical mirror of claim 1, wherein the electrolytic solution comprises:
choline chloride and glycerol;
water; and
copper salt.

19. A reversible electrochemical mirror, comprising:
a first electrode;
a second electrode deposited with metal atoms; and
an electrolytic solution defined in claim 1, wherein the electrolytic solution is disposed between the first electrode and second electrode,
wherein the application of negative potential on the first electrode relative to the second electrode causes the deposited metal atoms to be dissolved from the second electrode into the electrolytic solution and to be electrodeposited from the electrolytic solution onto the first electrode; and
wherein the application of positive potential on the first electrode relative to the second electrode causes the deposited metal atoms to be dissolved from the first electrode into the electrolytic solution and to be electrodeposited from the electrolytic solution onto the second electrode.

20. Use of an electrolytic solution in a reversible electrochemical mirror, wherein the electrolytic solution comprises:
deep eutectic solvent;
at least about 20 wt % aqueous solvent based on the total weight of deep eutectic solvent and aqueous solvent; and
metal salt.
